(19) United States
(12) Patent Application Publication
(10) Pub. No.: US 2026/0235038 A1
(43) Pub. Date: Aug. 13, 2026

(54) GAS TURBINE ENGINE

(71) Applicant: General Electric Company, Evendale, OH (US)

(72) Inventors: Brandon Wayne Miller, Liberty Township, OH (US); Randy M. Vondrell, Newport, KY (US); David Marion Ostdiek, Liberty Township, OH (US); Craig William Higgins, Liberty Township, OH (US); Alexander Kimberley Simpson, Cincinnati, OH (US); Arthur W. Sibbach, Boxford, MA (US)

(21) Appl. No.: 18/988,382

(22) Filed: Dec. 19, 2024

Related U.S. Application Data
(63) Continuation-in-part of application No. 18/675,270, filed on May 28, 2024, now Pat. No. 12,523,188.
Application No. 18/675,270 is a continuation of application No. 17/879,384, filed on Aug. 2, 2022, now Pat. No. 12,031,504.

(51) Int. Cl. F02K 3/065; F02C 3/06

(52) U.S. Cl. CPC F01D 7/00; F01D 1/30; F02K 3/075; F02K 3/077

(57) ABSTRACT

A gas turbine engine includes: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, wherein the core bypass ratio is a ratio of the airflow through the fan duct to the airflow through the core duct.

### CROSS-REFERENCE TO RELATED APPLICATIONS

This application is a continuation in part application of U.S. application Ser. No. 18/675,270, filed May 28, 2024, which is a continuation application of U.S. application Ser. No. 17/879,384 filed Aug. 2, 2022. Each of these applications is hereby incorporated by reference in their entireties.

### FIELD

The present disclosure relates to a gas turbine engine with a third stream.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a three-stream engine in accordance with an exemplary embodiment of the present disclosure.

FIG. 2 is a close-up, schematic view of the exemplary three-stream engine of FIG. 1.

FIG. 3 is a close-up view of an area surrounding a leading edge of a core cowl of the exemplary three-stream engine of FIG. 2.

FIGS. 4A through 4H are tables depicting numerical values showing the relationships between various parameters in accordance with various example embodiments of the present disclosure.

FIGS. 5A through 5D are graphs depicting a range of thrust to power airflow ratios and core bypass ratios in accordance with various example embodiments of the present disclosure.

FIG. 6 is a schematic view of a turboprop engine in accordance with an exemplary aspect of the present disclosure.

FIG. 7 is a schematic view of a direct drive, ducted, turbofan engine in accordance with an exemplary aspect of the present disclosure.

FIG. 8 is a schematic view of a geared, ducted, turbofan engine in accordance with an exemplary aspect of the present disclosure.

FIG. 9 is a schematic view of a geared, ducted, turbofan engine in accordance with another exemplary aspect of the present disclosure.

FIG. 10 is a schematic view of an unducted gas turbine engine in accordance with another exemplary aspect of the present disclosure.

FIG. 11 is a schematic view of an unducted gas turbine engine in accordance with yet another exemplary aspect of the present disclosure.

FIG. 12 is a schematic view of an unducted gas turbine engine in accordance with still another exemplary aspect of the present disclosure.

FIG. 13 is a perspective view of a variable pitch fan of the exemplary gas turbine engine of FIGS. 1 and 2 according to an exemplary embodiment of the present subject matter.

FIG. 14 is a schematic side view of an actuation assembly of the exemplary variable pitch fan of FIG. 13, where the fan blades are in a feathered position.

FIG. 15 is a schematic side view of an actuation assembly of the exemplary variable pitch fan of FIG. 13, where the fan blades are in a flat pitch position.

FIG. 16 is a diagrammatic view of the pitch scheduling ring showing the scheduling slot for two adjacent fan blades as the scheduling ring is rotated in accordance with embodiments of the present disclosure.

FIG. 17 a diagrammatic view of the pitch scheduling ring showing the scheduling slot for two adjacent fan blades as the scheduling ring is rotated in accordance with embodiments of the present disclosure.

FIG. 18 is a perspective view of a disk and associated trunnion mechanisms of the exemplary variable pitch fan of FIG. 13.

FIG. 19 is a partial cross-sectional view of a disk segment and trunnion mechanism of FIG. 18.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “disk loading” refers to an average pressure change across a plurality of rotor blades of a rotor assembly, such as the average pressure change across a plurality of fan blades of a fan.

The term “rated speed” refers to an operating condition of an engine whereby the engine is operating in the maximum, full load operating condition that is rated by the manufacturer. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

Generally, an aeronautical gas turbine engine includes a fan to provide a desired amount of thrust without overloading the fan blades (i.e., without increasing a disk loading of the fan blades of the fan beyond a certain threshold), and therefore to maintain a desired overall propulsive efficiency for the gas turbine engine. Conventional gas turbine engine design practice has been to provide an outer nacelle surrounding the fan to provide relatively efficient thrust for the gas turbine engine. Such a configuration, sometimes referred to as a turbofan engine configuration, may generally limit a permissible size of the fan (i.e., a diameter of the fan). However, the inventors of the present disclosure have found that gas turbine engine design is now driving the diameter of the fan higher to provide as much thrust for the gas turbine engine as possible from the fan to improve an overall propulsive efficiency of the gas turbine engine.

By increasing the fan diameter, an installation of the gas turbine engine becomes more difficult. In addition, if an outer nacelle is maintained, the outer nacelle may become weight prohibitive with some larger diameter fans. Further, as the need for gas turbine engines to provide more thrust continues, the thermal demands on the gas turbine engines correspondingly increases.

The inventors of the present disclosure found that for a three stream gas turbine engine having a primary fan and a secondary fan, with the secondary fan being a ducted fan providing an airflow to a third stream of the gas turbine engine, an overall propulsive efficiency of the gas turbine engine that results from providing a high diameter fan may be maintained at a high level, while reducing the size of the primary fan. Such a configuration may maintain a desired overall propulsive efficiency for the gas turbine engine, or unexpectedly may in fact increase the overall propulsive efficiency of the gas turbine engine.

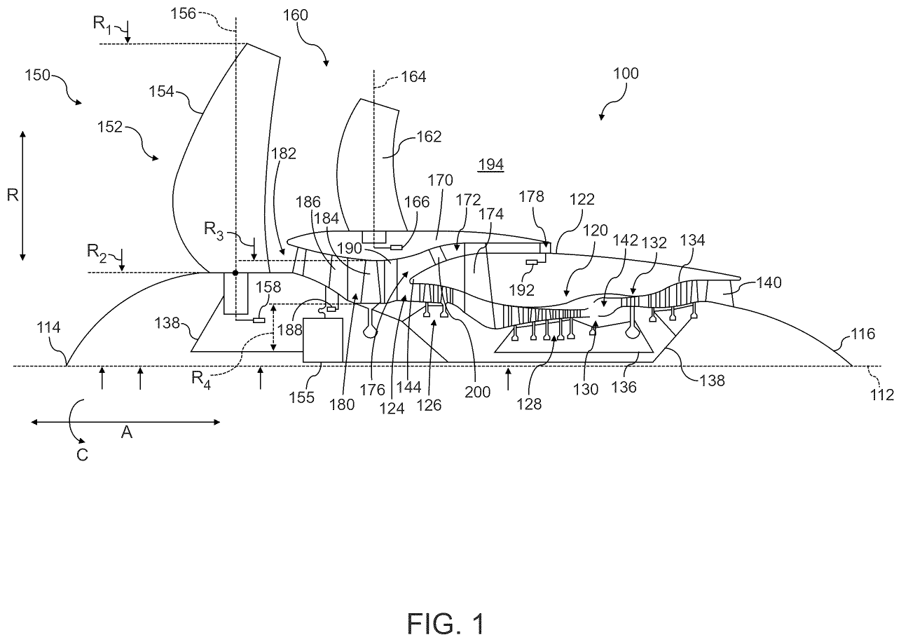

The inventors proceeded in the manner of designing a gas turbine engine with given primary fan characteristics, secondary fan characteristics, and turbomachine characteristics; checking the propulsive efficiency of the designed gas turbine engine; redesigning the gas turbine engine with varying primary fan, secondary fan, and turbomachine characteristics; rechecking the propulsive efficiency of the redesigned gas turbine engine; etc. during the design of several different types of gas turbine engines, including the gas turbine engines described below with reference to FIGS. 1 and 6 through 10. During the course of this practice of studying/evaluating various primary fan characteristics, secondary fan characteristics, and turbomachine characteristics considered feasible for best satisfying mission requirements, it was discovered that certain relationships exist between a ratio of an airflow through the bypass passage and the third stream to an airflow through a core duct (referred to hereinbelow as a thrust to power airflow ratio), as well as between a ratio of an airflow through the third steam to the airflow through the core duct (referred to hereinbelow as a core bypass ratio). In particular, the inventors of the present disclosure have found that these ratios can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

Referring now to FIG. 1, a schematic cross-sectional view of a gas turbine engine 100 is provided according to an example embodiment of the present disclosure. Particularly, FIG. 1 provides a gas turbine engine having a rotor assembly with a single stage of unducted rotor blades. In such a manner, the rotor assembly may be referred to herein as an “unducted fan,” or the entire engine 100 may be referred to as an “unducted gas turbine engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Further, each fan blade 154 defines a fan blade tip radius R₁ along the radial direction R from the longitudinal axis 112 to the tip, and a hub radius (or inner radius) R₂ along the radial direction R from the longitudinal axis 112 to the base of each fan blade 154 (i.e., from the longitudinal axis 112 to a radial location where each fan blade 154 meets a front hub of the gas turbine engine 100 at a leading edge of the respective fan blade 154). As will be appreciated, a distance from the base of each fan blade 154 to a tip of the respective fan blade 154 is referred to as a span of the respective fan blade 154. Further, the fan 152, or rather each fan blade 154 of the fan 152, defines a fan radius ratio, RqR, equal to R₂ divided by R₁. As the fan 152 is the primary fan of the engine 100, the fan radius ratio, RqR, of the fan 152 may be referred to as the primary fan radius ratio, RqR_{Prim.-Fan}.

Moreover, each fan blade 154 defines a central blade axis 156. For this embodiment, each fan blade 154 of the fan 152 is rotatable about their respective central blade axis 156, e.g., in unison with one another. One or more actuators 158 are provided to facilitate such rotation and therefore may be used to change a pitch of the fan blades 154 about their respective central blades' axes 156. A pitch of the fan blade 154 is an angle of the blade 154 with respect to airflow. Changing pitch allows for control of thrust produced by the engine 100.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

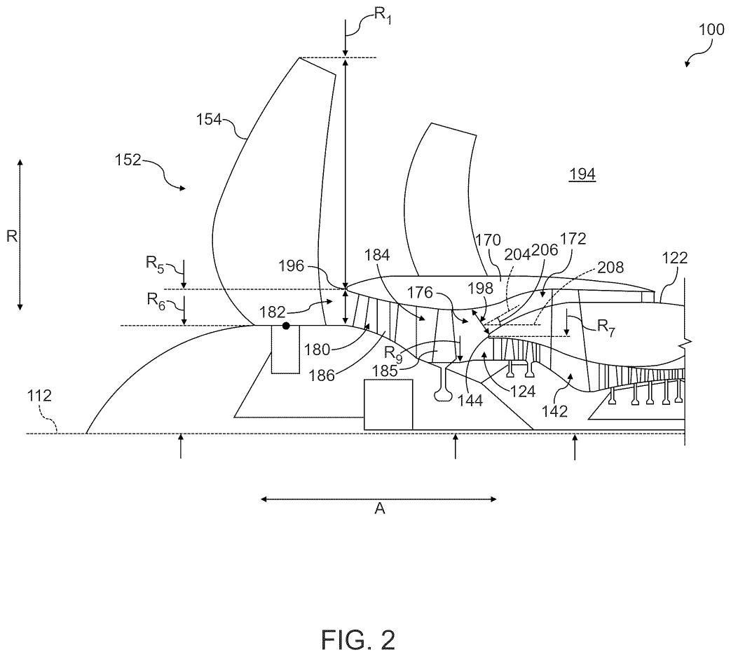

The ducted fan 184 includes a plurality of fan blades (not separately labeled in FIG. 1; see fan blades 185 labeled in FIG. 2) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween. Further, each fan blade of the ducted fan 184 defines a fan blade tip radius R₃ along the radial direction R from the longitudinal axis 112 to the tip, and a hub radius (or inner radius) R₄ along the radial direction R from the longitudinal axis 112 to the base of the respective fan blades of the ducted fan 184 (i.e., a location where the respective fan blades of the ducted fan 184 meet an inner flowpath liner at a leading edge of the respective fan blades of the ducted fan 184). As will be appreciated, a distance from the base of each fan blade of the ducted fan 184 to a tip of the respective fan blade is referred to as a span of the respective fan blade. Further, the ducted fan 184, or rather each fan blade of the ducted fan 184, defines a fan radius ratio, RqR, equal to R₄ divided by R₃. As the ducted fan 184 is the secondary fan of the engine 100, the fan radius ratio, RqR, of the ducted fan 184 may be referred to as the secondary fan radius ratio, RqR_{Sec.-Fan}.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. The inlet duct 180 is wider than the core duct 142 along the radial direction R. The inlet duct 180 is also wider than the fan duct 172 along the radial direction R. The secondary fan 184 is positioned at least partially in the inlet duct 180.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through duct 172 as a heat sink and correspondingly increases the temperature of the air downstream of the heat exchanger 200 and exiting the fan exhaust nozzle 178.

Referring now to FIG. 2, a close-up, simplified, schematic view of the gas turbine engine 100 of FIG. 1 is provided. The gas turbine engine 100, as noted above, includes a primary fan, or rather fan 152 having fan blades 154, and a secondary fan, or rather ducted fan 184 having fan blades 185. Airflow from the fan 152 is split between a bypass region 194 (as defined below) and the inlet duct 180 by an inlet splitter 196. Airflow from the ducted fan 184 is split between the fan duct 172 and the core duct 142 by the leading edge 144 (sometimes also referred to as a fan duct splitter).

The exemplary gas turbine engine 100 depicted in FIG. 2 further defines a primary fan outer fan area, A_{P_Out}, a primary fan inner fan area, A_{P_In}, a secondary fan outer fan area, A_{S_Out}, and a secondary fan inner fan area, A_{S_In}.

The primary fan outer fan area, A_{P_Out}, refers to an area defined by an annulus representing a portion of the fan 152 located outward of the inlet splitter 196 of the fan cowl 170. In particular, the gas turbine engine 100 further defines a fan cowl splitter radius, R₅. The fan cowl splitter radius, R₅, is defined along the radial direction R from the longitudinal axis 112 to the inlet splitter 196. The primary fan outer fan area, A_{P_Out}, refers to an area defined by the formula: πR₁²−πR₅².

The primary fan inner fan area, A_{P_In}, refers to an area defined by an annulus representing a portion of the fan 152 located inward of the inlet splitter 196 of the fan cowl 170. In particular, the gas turbine engine 100 further defines an engine inlet inner radius, R₆. The engine inlet inner radius, R₆, is defined along the radial direction R from the longitudinal axis 112 to an inner casing defining the engine inlet 182 directly inward along the radial direction R from the inlet splitter 196. The primary fan inner fan area, A_{P_In}, refers to an area defined by the formula: πR₅²−πR₆².

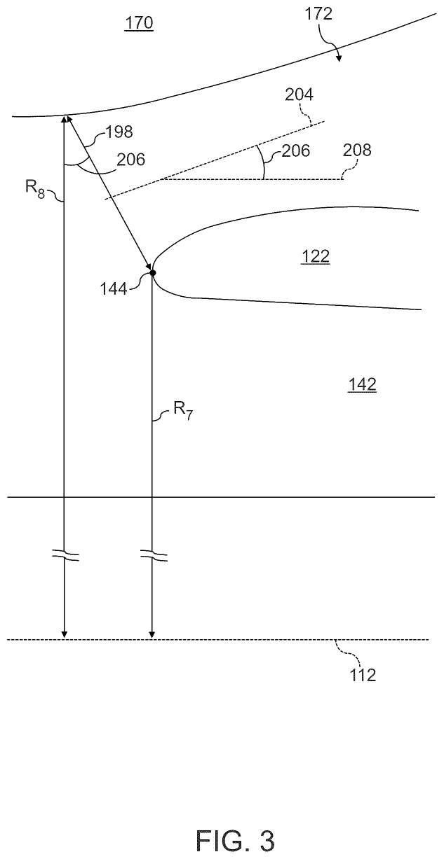

The secondary fan outer fan area, A_{S_Out}, refers to an area representing a portion of an airflow from the ducted fan 184 that is provided to the fan duct 172. In particular, the leading edge 144 defines a leading edge radius, R₇, and the gas turbine engine 100 defines an effective fan duct inlet outer radius, R₈ (see FIG. 3). The leading edge radius, R₇, is defined along the radial direction R from the longitudinal axis 112 to the leading edge 144.

Referring briefly to FIG. 3, providing a close-up view of an area surrounding the leading edge 144, the fan duct 172 defines a cross-wise height 198 measured from the leading edge 144 to the fan cowl 170 in a direction perpendicular to a mean flow direction 204 of an airflow through a forward 10% of the fan duct 172. An angle 206 is defined by the mean flow direction 204 relative to a reference line 208 extending parallel to the longitudinal axis 112. The angle 206 is referred to as θ. In certain embodiments, the angle 206 may be between 5 degrees and 80 degrees, such as between 10 degrees and 60 degrees (an increased angle is a counterclockwise rotation in FIG. 3). The effective fan duct inlet outer radius, R₈, is defined along the radial direction R from the longitudinal axis 112 to where the cross-wise height 198 meets the fan cowl 170. The secondary fan outer fan area, A_{S_Out}, refers to an area defined by the formula:

$$\frac{π ( {R}_{8}^{2} - {R}_{7}^{2} )}{cos ( θ )} .$$

Referring back to FIG. 2, the secondary fan inner fan area, A_{S_In}, refers to an area defined by an annulus representing a portion of the ducted fan 184 located inward of the leading edge 144 of the core cowl 122. In particular, the gas turbine engine 100 further defines a core inlet inner radius, R₉. The core inlet inner radius, R₉, is defined along the radial direction R from the longitudinal axis 112 to an inner casing defining the core inlet 124 directly inward along the radial direction R from the leading edge 144. The secondary fan inner fan area, A_{S_In}, refers to an area defined by the formula:

$$π {R}_{7}^{2} - π {R}_{9}^{2} .$$

The primary fan outer fan area, A_{P_Out}, the primary fan inner fan area, A_{P_In}, the secondary fan outer fan area, A_{S_Out}, and the secondary fan inner fan area, A_{S_In}, may be used in defining various airflow ratios for the engine 100. In particular, it will be appreciated that the exemplary engine 100 of FIGS. 1 through 3 further defines a thrust to power airflow ratio and a core bypass ratio, which as discussed herein are used to define an engine in accordance with the present disclosure. The thrust to power airflow ratio is a ratio of an airflow through the bypass region 194 of the engine 100 and through the fan duct 172 to an airflow through the core duct 142. Further, the core bypass ratio is a ratio of an airflow through the fan duct 172 to the airflow through the core duct 142. These ratios are calculated while the engine 100 is operating at a rated speed during standard day operating conditions, and the amounts of airflow used to calculate these ratios are each expressed as a mass flowrate in the same units (mass per unit time).

More specifically, the amount of airflow through the engine's bypass passage is determined using a fan pressure ratio for the fan 152 while operating at the rated speed during standard day operating conditions, and the primary fan outer fan area, A_{P_Out}. The amount of airflow through the inlet duct 180 is determined using a fan pressure ratio for the fan 152 while operating at a rated speed during standard day operating conditions, and the primary fan inner fan area, A_{P_In}. The amount of airflow through the fan duct 172 and the amount of airflow through the core duct 142 is determined based on the amount of airflow through the inlet duct 180 and the secondary fan outer fan area, A_{S_Out}, and the secondary fan inner fan area, A_{S_In}

As alluded to earlier, the inventors discovered, unexpectedly during the course of gas turbine engine design—i.e., designing gas turbine engines (e.g., both ducted and unducted gas turbine engines and turboprop engines) having a variety of different primary fan and secondary fan characteristics- and evaluating an overall propulsive efficiency, significant relationships exist in a ratio of an airflow through a bypass passage and through a third stream to an airflow through a core duct (referred to herein as a thrust to power airflow ratio), as well as in a ratio of an airflow through the third steam to the airflow through the core duct (referred to herein as a core bypass ratio). These relationships can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

As will be appreciated, it may generally be desirable to increase a fan diameter in order to provide a higher thrust to power airflow ratio, which typically correlates to a higher overall propulsive efficiency. However, increasing the fan diameter too much may actually result in a decrease in propulsive efficiency at higher speeds due to a drag from the fan blades. Further, increasing the fan diameter too much may also create prohibitively heavy fan blades, creating installation problems due to the resulting forces on the supporting structure (e.g., frames, pylons, etc.), exacerbated by a need to space the engine having such fan blades further from a mounting location on the aircraft to allow the engine to fit, e.g., under/over the wing, adjacent to the fuselage, etc.

Similarly, it may generally be desirable to increase an airflow through the fan duct relative to the core duct in order to provide a higher core bypass ratio, as such may also generally correlate to a higher overall propulsive efficiency. Notably, however, the higher the core bypass ratio, the less airflow provided to the core of the gas turbine engine. For a given amount of power needed to drive, e.g., a primary fan and a secondary fan of the gas turbine engine, if less airflow is provided, either a maximum temperature of the core needs to be increased or a size of the primary fan or secondary fan needs to be decreased. Such a result can lead to either premature wear of the core or a reduction in propulsive efficiency of the gas turbine engine.

As noted above, the inventors of the present disclosure discovered bounding the relationships defined by the thrust to power airflow ratio and core bypass ratio can result in a gas turbine engine maintaining or even improving upon a desired propulsive efficiency, while also taking into account the gas turbine engine's packaging concerns and weight concerns, and also providing desired thermal management capabilities. The relationship discovered, infra, can identify an improved engine configuration suited for a particular mission requirement, one that takes into account installation, packaging and loading, thermal sink needs and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight, and thermal sink requirements could be greatly diminished, thereby facilitating a more rapid down selection of designs to consider as a gas turbine engine is being developed. Such a benefit provides more insight into the requirements for a given gas turbine engine well before specific technologies, integration and system requirements are developed fully. Such a benefit avoids late-stage redesign.

The desired relationships providing for the improved gas turbine engine, discovered by the inventors, are expressed as:

$$TPAR = ( {A}_{B} + {A}_{3 S} ) / {A}_{C} \qquad ( 1 )$$

$$CBR = {A}_{3 S} / {A}_{C} \qquad ( 2 )$$

where TPAR is a thrust to power airflow ratio, CBR is a core bypass ratio, A_{B} is an airflow through a bypass passage of the gas turbine engine while the engine is operated at a rated speed during standard day operating conditions, A_{3S} is an airflow through a third stream of the gas turbine engine while the engine is operated at the rated speed during standard day operating conditions, and A_{C} is an airflow through a core of the gas turbine engine while the engine is operated at the rated speed during standard day operating conditions. The airflow through the core of the gas turbine engine may refer to an airflow through an upstream end of the core (e.g., an airflow through a first stage of a high pressure compressor of the core). A_{B}, A_{3S}, and A_{C} are each expressed as mass flowrate, with the same units as one another.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| R₁/R₃ | Tip radius ratio | 1.35 to 10, such as 2 to 7, such |
| | | as 3 to 5, such as at least 3.5, |
| | | such as at least 3.7, such as at |
| | | least 4, such as up to 10, such |
| | | as up to 7 |
| RqR_{Sec.-Fan} | Secondary fan | 0.2 to 0.9, such as 0.2 to 0.7, |
| | radius ratio | such as 0.57 to 0.67 |
| RqR_{Prim.-Fan} | Primary fan radius | 0.2 to 0.4, such as 0.25 to 0.35 |
| | ratio | |
| TPAR | Thrust to power | 3.5 to 100, such as 4 to 75 |
| | airflow ratio | (see also, TABLE 2, below) |
| CBR | Core Bypass Ratio | 0.1 to 10, such as 0.3 to 5 |
| | | (see also, TABLE 2, below) |

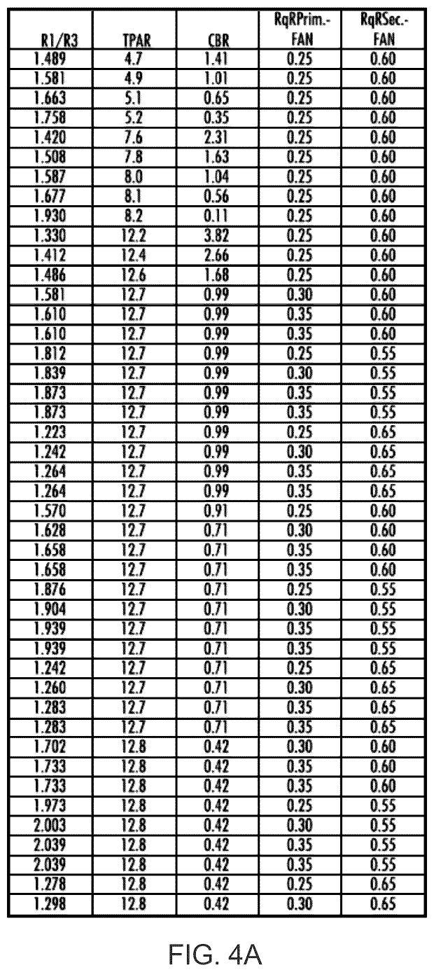

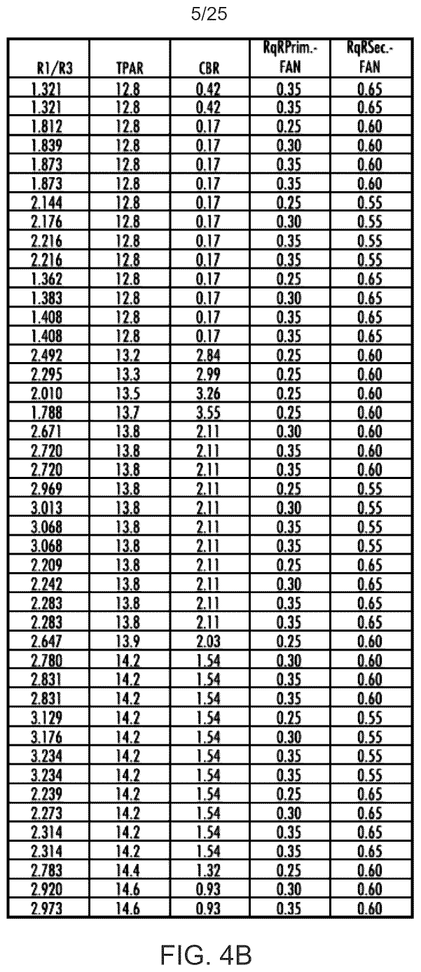

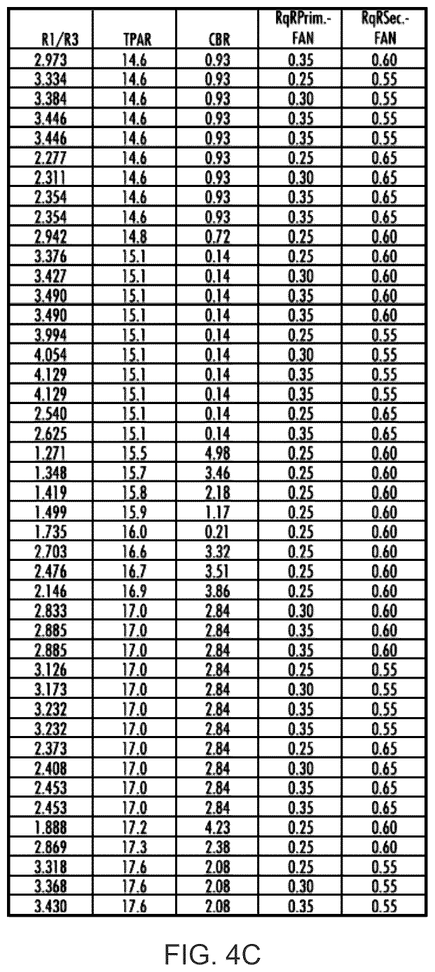

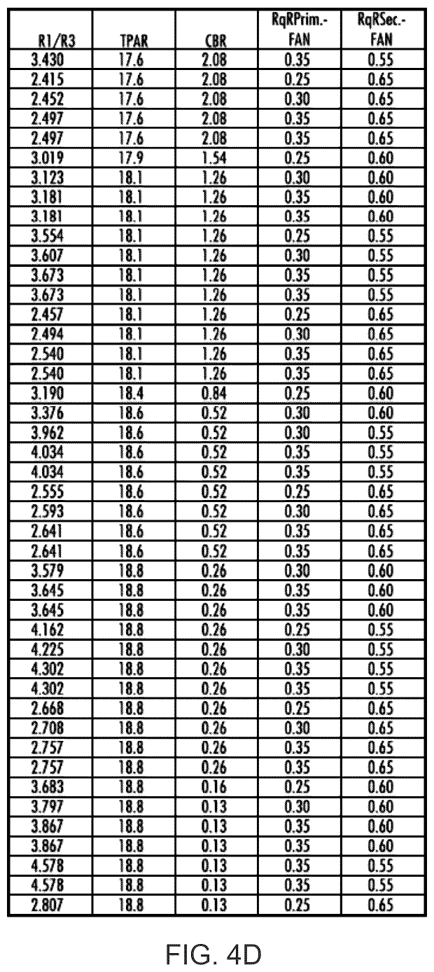

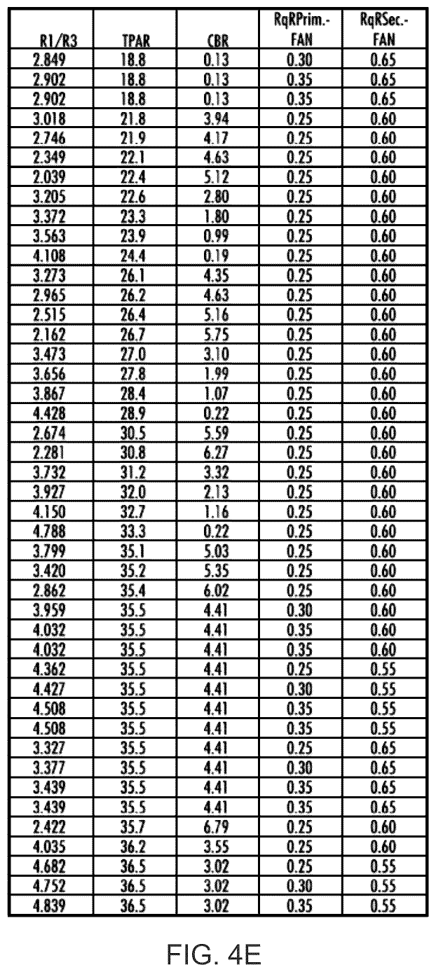

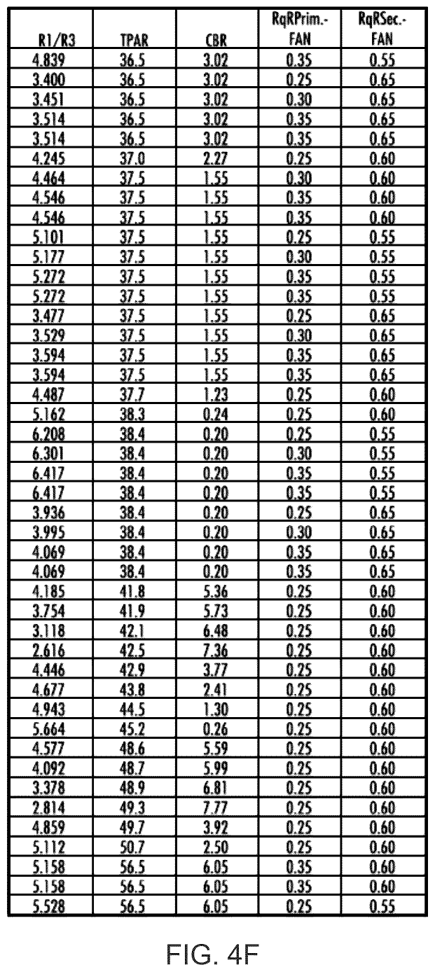

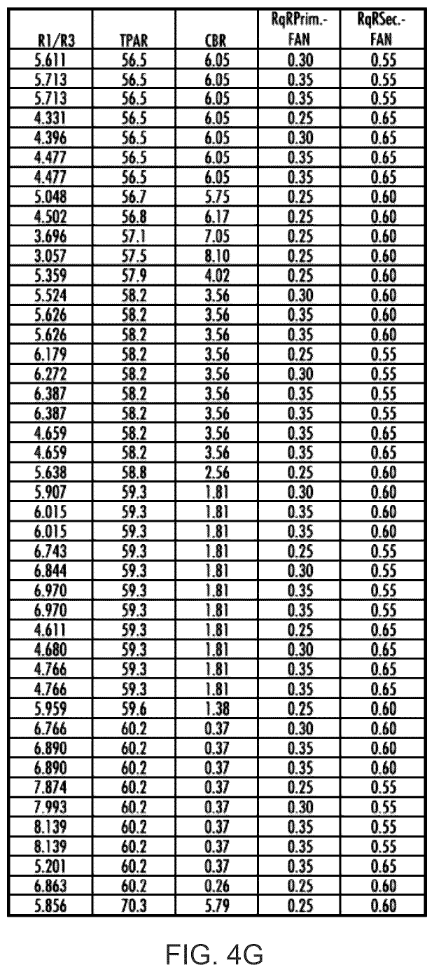

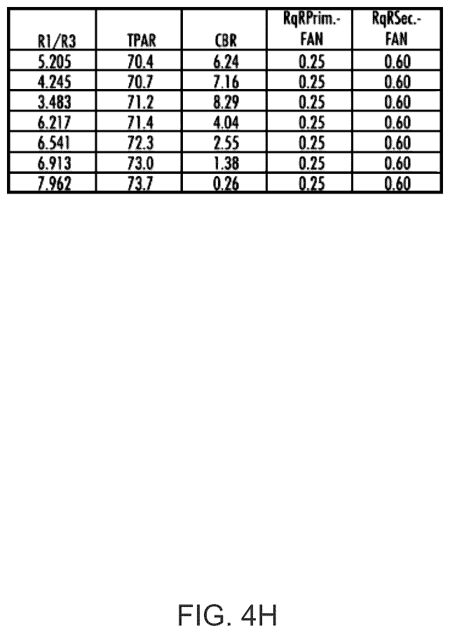

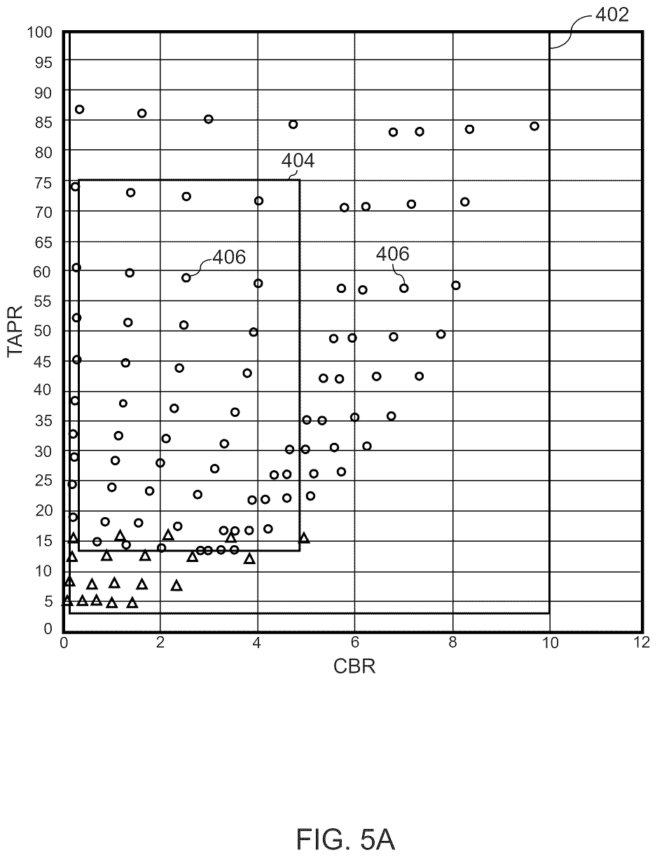

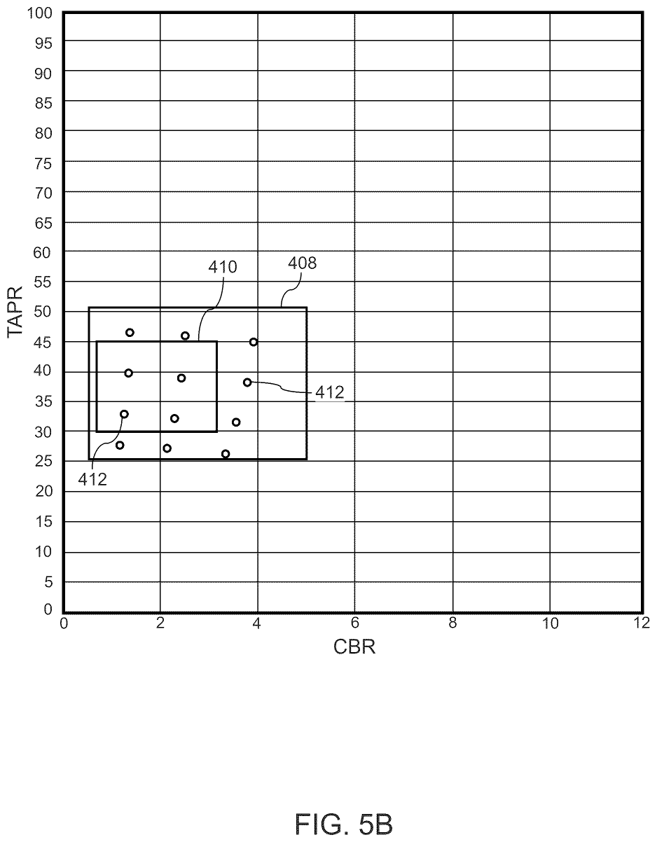

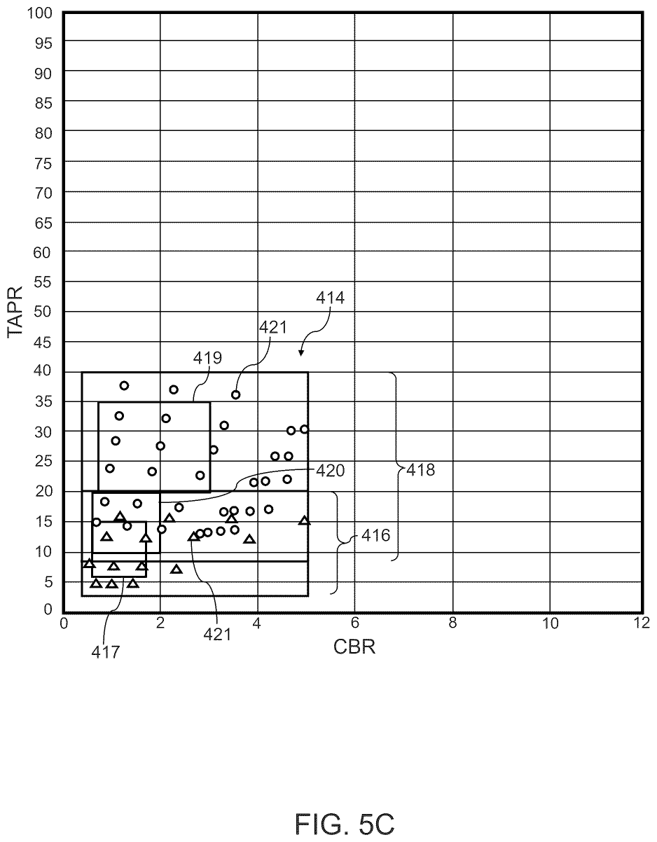

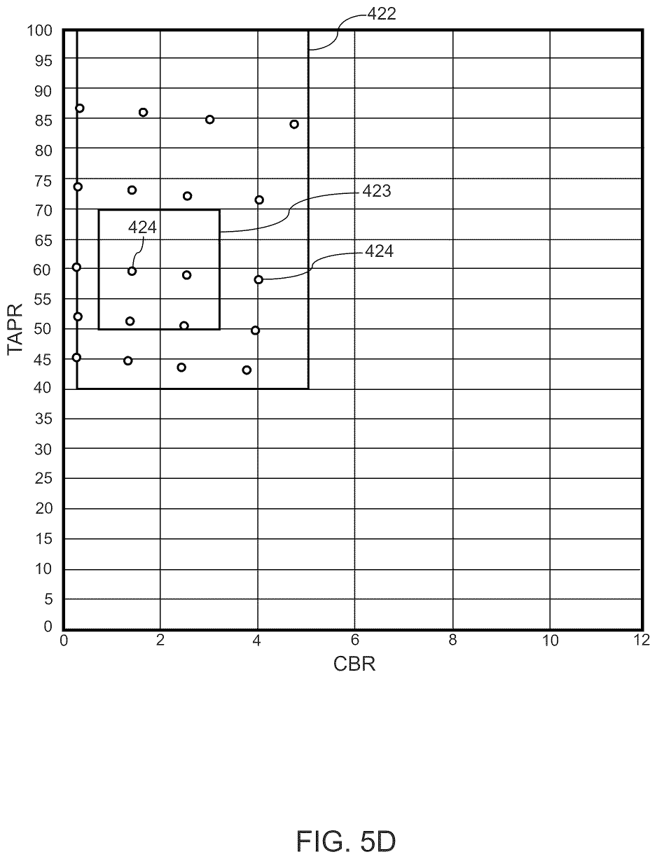

Referring now to FIGS. 4A through 4H and 5A through 5D, the relationships between the various parameters of Expressions (1) and (2) of exemplary gas turbine engines are illustrated in accordance with one or more exemplary embodiments of the present disclosure. In particular, FIGS. 4A through 4H provide a table including numerical values corresponding to several of the plotted gas turbine engines in FIGS. 5A through 5D. FIGS. 5A through 5D are plots of gas turbine engines in accordance with one or more exemplary embodiments of the present disclosure, showing the TPAR (Y-Axis) and the CBR (X-axis). FIGS. 5A through 5D highlight preferred subranges, including subranges for unducted engines, ducted engines, and turboprop engines, as discussed hereinbelow.

Referring particularly to FIG. 5A, a first range 402 and a second range 404 are provided, and exemplary embodiments 406 are plotted. The exemplary embodiments 406 include a variety of gas turbine engine types in accordance with aspects of the present disclosure, including unducted gas turbine engines, ducted gas turbine engines (turbofan engines), and turboprop engines. The first range 402 corresponds to a TPAR between 3.5 and 100 and a CBR between 0.1 and 10. The first range 402 captures the benefits of the present disclosure across the variety of engine types. The second range 404 corresponds to a TPAR between 14 and 75 and a CBR between 0.3 and 5. The second range 404 may provide more desirable TPAR and CBR relationships across the variety of engine types to achieve propulsive efficiency, while still providing packaging and weight benefits, thermal benefits, etc.

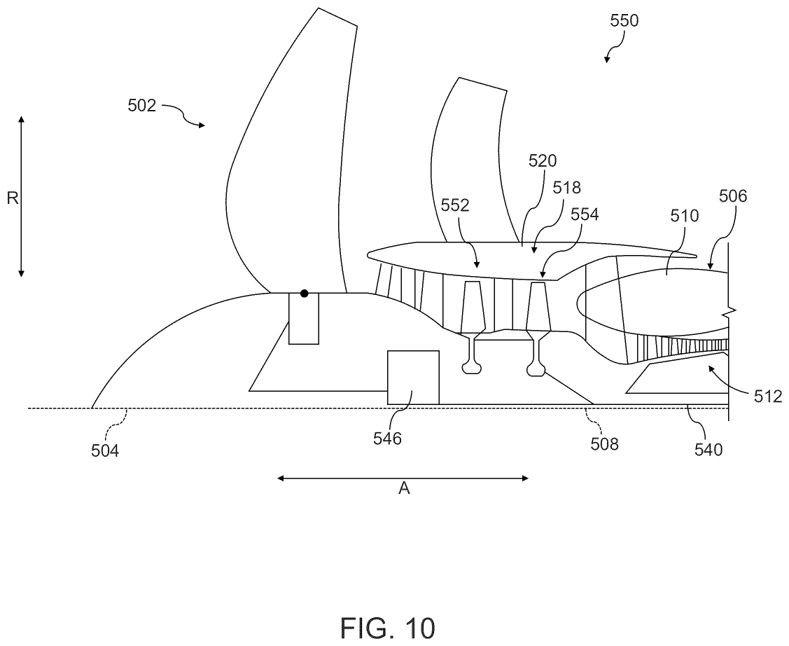

Referring particularly to FIG. 5B, a third range 408 and a fourth range 410 are provided, and exemplary embodiments 412 are plotted. The exemplary embodiments 412 include a variety of unducted gas turbine engines in accordance with aspects of the present disclosure. In particular, the exemplary embodiments 412 include a variety of gas turbine engines having an unducted primary fan, similar to the exemplary embodiments described herein with reference to FIGS. 1 and 10. The third range 408 corresponds to a TPAR between 30 and 56 and a CBR between 0.3 and 5. The third range 408 captures the benefits of the present disclosure for unducted gas turbine engines. The fourth range 410 corresponds to a TPAR between 35 and 50 and a CBR between 0.5 and 3. The fourth range 410 may provide more desirable TPAR and CBR relationships for the unducted gas turbine engines to achieve propulsive efficiency, while still providing packaging and weight benefits, thermal benefits, etc.

As will be appreciated, the unducted gas turbine engines may have, on the whole, a higher TPAR as compared to the ducted gas turbine engines (see FIG. 5C), enabled by a lack of an outer nacelle or other casing surrounding a primary fan. The range of CBR values in the fourth range 410 isn't as large as the range of CBR values in the third range 408, as in the embodiments with a higher TPAR, the CBR needs to be lower to provide a necessary amount of airflow to a core of the engine without exceeding temperature thresholds or requiring an undesired reduction in a size of the primary fan.

The inventors of the present disclosure have found that the TPAR values and CBR values in the third and fourth ranges 408, 410 shown may provide a desirable propulsive benefit, while still enabling operation of the core in a reasonable manner, and balancing installation and thermal load considerations.

Referring particularly to FIG. 5C, a fifth range 414, a sixth range 416, a seventh range 417, an eighth range 418, a ninth range 419, and a tenth range 420 are provided, and exemplary embodiments 421 are plotted. The exemplary embodiments 421 include a variety of ducted gas turbine engines in accordance with aspects of the present disclosure. In particular, the exemplary embodiments 421 include a variety of gas turbine engines having a ducted primary fan, similar to the exemplary embodiments described herein with reference to FIGS. 7 through 9. The fifth range 414 corresponds to a TPAR between 3.5 and 40 and a CBR between 0.3 and 5. The fifth range 414 captures the benefits of the present disclosure for ducted gas turbine engines.

The sixth range 416 corresponds to a TPAR between 3.5 and 20 and a CBR between 0.2 and 5. The sixth range 416 captures the benefits of the present disclosure for ducted gas turbine engines in a direct drive configuration (see, e.g., FIG. 7). As will be appreciated, with a ducted, direct drive gas turbine engine, a primary fan may be smaller, limiting a TPAR. The seventh range 417, which also corresponds to ducted gas turbine engines in a direct drive configuration, corresponds to a TPAR between 6 and 15 and a CBR between 0.3 and 1.8, and may represent a more preferrable range.

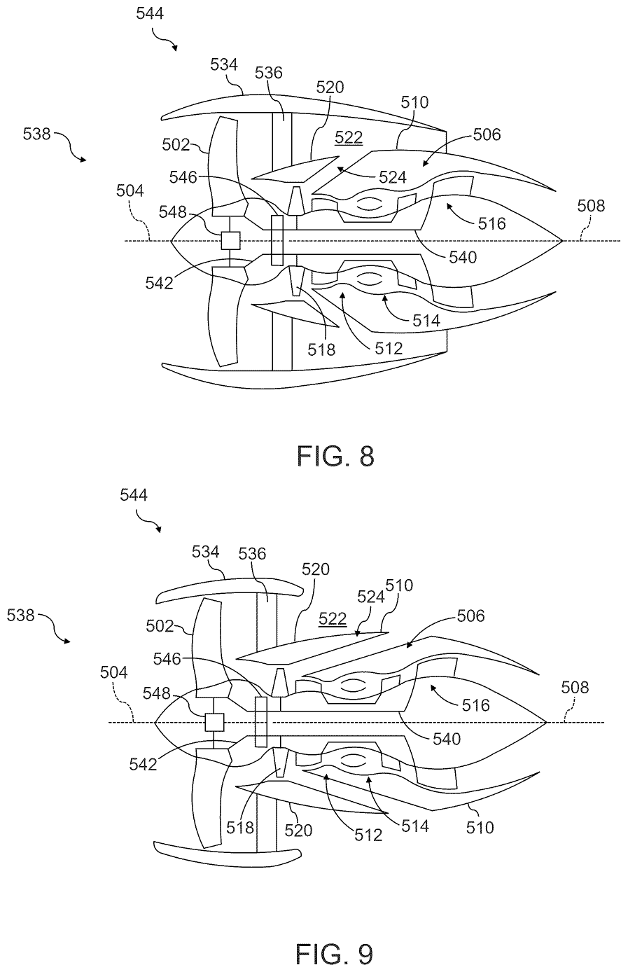

The eighth range 418 corresponds to a TPAR between 8 and 40 and a CBR between 0.2 and 5. The eighth range 418 captures the benefits of the present disclosure for ducted gas turbine engines in a geared configuration (see, e.g., FIGS. 8 and 9). As will be appreciated, with a ducted, geared gas turbine engine, a primary fan may be larger as compared to a ducted, direct drive gas turbine engine, allowing for a larger TPAR. TPAR is, in turn, limited by an allowable nacelle drag and fan operability.

The ninth range 419 corresponds to ducted gas turbine engines in a geared configuration having a variable pitch primary fan (see FIGS. 8 and 9) and the tenth range 420 corresponds to ducted gas turbine engines in a geared configuration having a fixed pitch primary fan. Inclusion of a variable pitch primary fan may allow for a larger fan, but may also necessitate higher heat rejection abilities for the gas turbine engine, which may, in turn increase a CBR. The ninth range 419 corresponds to a TPAR between 20 and 35 and a CBR between 0.5 and 3, and the tenth range 420 corresponds to a TPAR between 10 and 20 and a CBR between 0.3 and 2. It will be appreciated that in other exemplary aspects, a gas turbine engine of the present disclosure in a ducted, geared, variable pitch configuration may have TPAR between 15 and 40 and a CBR between 0.3 and 5, and a gas turbine engine in a ducted, geared, fixed pitch configuration may have TPAR between 8 and 25 and a CBR between 0.3 and 5.

As will be appreciated, the ducted gas turbine engines may have, on the whole, a lower TPAR than the unducted gas turbine engines as a result of an outer nacelle surrounding a primary fan (the outer nacelle becoming prohibitively heavy with higher diameter primary fans). Further, it will be appreciated that the TPAR values for geared engines may be higher than the TPAR values for direct drive engines, as inclusion of the gearbox allows the primary fan to rotate more slowly than the driving turbine, enabling a comparatively larger primary fan without overloading the primary fan or generating shock losses at a tip of the primary fan. The range of CBR values may generally be relatively high given the relatively low TPAR values (since a relatively high amount of airflow is provided to a secondary fan through an engine inlet when the TPAR values are low), as a necessary amount of airflow to a core of the ducted gas turbine engine may still be provided with a relatively high CBR without exceeding temperature thresholds or requiring a reduction in a size of the primary fan.

The inventors of the present disclosure have found that the TPAR values and CBR values in the fifth, sixth, seventh, eighth, ninth, and tenth ranges 414, 416, 417, 418, 419, 420 shown may provide a desirable propulsive benefit, while still enabling operation of the core in a reasonable manner, and balancing installation and thermal load considerations.

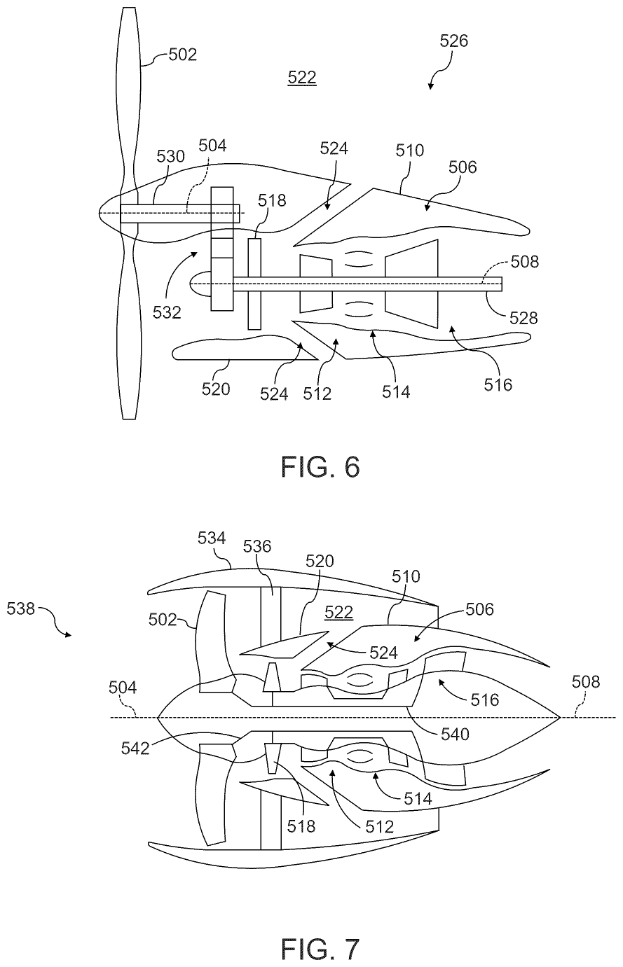

Referring particularly to FIG. 5D, an eleventh range 422 and a twelfth range 423 are provided, and exemplary embodiments 424 are plotted. The exemplary embodiments 424 include a variety of turboprop gas turbine engines in accordance with aspects of the present disclosure. In particular, the exemplary embodiments 424 include a variety of turboprop gas turbine engine similar to the exemplary embodiment described herein with reference to FIG. 6. The eleventh range 422 corresponds to a TPAR between 40 and 100 and a CBR between 0.3 and 5. The eleventh range 422 captures the benefits of the present disclosure for turboprop gas turbine engines. The twelfth range 423 corresponds to a TPAR between 50 and 70 and a CBR between 0.5 and 3, and may represent a more preferrable range.

As will be appreciated, the turboprop gas turbine engines may have, on the whole, higher TPAR values than turbofan engines, enabled by the lack of an outer nacelle or other casing surrounding a primary fan and a relatively slow operational speed of the primary fan and aircraft incorporating the turboprop gas turbine engine. The range of CBR values in the eleventh range 422 and the twelfth range 423 may be relatively small, as less air may be provided through a third stream with such a high TPAR without compromising operation of a core of the gas turbine engine.

The inventors of the present disclosure have found that the TPAR values and CBR values in the eleventh range 422 and twelfth range 423 shown may provide a desirable propulsive benefit, while still enabling operation of the core in a reasonable manner, and balancing installation and thermal load considerations.

TABLE 2, below provides a summary of TPAR values and CBR values for various gas turbine engines in accordance with one or more exemplary aspects of the present disclosure.

TABLE 2

| Engine Type | TPAR Value | CBR Value |
|---|---|---|
| All Aeronautical Gas Turbine Engines | 3.5 to 100 | 0.1 to 10 |
| (“GTE”) | | |
| All Aeronautical GTE | 4 to 75 | 0.3 to 5 |
| Open Rotor GTE | 30 to 60 | 0.3 to 5 |
| Open Rotor GTE | 35 to 50 | 0.5 to 3 |
| Ducted Gas GTE | 3.5 to 40 | 0.2 to 5 |
| Ducted, Geared GTE | 8 to 40 | 0.2 to 5 |
| Ducted, Geared, Variable Pitch GTE | 15 to 40 | 0.3 to 5 |
| Ducted, Geared, Variable Pitch GTE | 20 to 35 | 0.5 to 3 |
| Ducted, Geared, Fixed-Pitch GTE | 8 to 25 | 0.2 to 5 |
| Ducted, Geared, Fixed-Pitch GTE | 10 to 20 | 0.3 to 2 |
| Ducted, Direct Drive GTE | 3.5 to 20 | 0.2 to 5 |
| Ducted, Direct Drive GTE (lower flight | 6 to 20 | 0.2 to 5 |
| speed) | | |
| Ducted, Direct Drive GTE (lower flight | 8 to 15 | 0.3 to 1.8 |
| speed) | | |
| Ducted, Direct Drive GTE (higher flight | 3.5 to 10 | 0.2 to 2 |
| speed) | | |
| Ducted, Direct Drive GTE (higher flight | 3.5 to 6 | 0.3 to 1.5 |
| speed) | | |
| Turboprop GTE | 40 to 100 | 0.3 to 5 |
| Turboprop GTE | 50 to 70 | 0.5 to 3 |

For the purposes of Table 2, the term “Ducted” refers to inclusion of an outer nacelle around a primary fan (see, e.g., FIGS. 7 to 9); “Open Rotor” refers to inclusion of an unducted primary fan (see, e.g., FIGS. 1, 10); “Geared” refers to inclusion of a reduction gearbox between the primary fan and a driving turbine (see, e.g., FIGS. 8 to 10); “Direct Drive” refers to exclusion of a reduction gearbox between the primary fan and a driving turbine (see, e.g., FIG. 7); “Variable Pitch” refers to inclusion of a pitch change mechanism for changing a pitch of fan blades on a primary fan (see, e.g., FIGS. 1, 8, 9); “Fixed Pitch” refers to exclusion of a pitch change mechanism for changing a pitch of fan blades on a primary fan (see, e.g., FIGS. 6 to 7); “lower flight speed” refers to an engine designed to operate at a flight speed less than 0.85 Mach; and “higher flight speed” refers to an engine designed to operate at a flight speed higher than 0.85 Mach.

It will be appreciated that although the discussion above is generally relating to the open rotor engine 100 described above with reference to FIGS. 1 and 2, in various embodiments of the present disclosure, the relationships outlined above with respect to, e.g., Expressions (1) and (2) may be applied to any other suitable engine architecture. For example, reference will now be made to FIGS. 6 through 12, each depicting schematically an engine architecture associated with the present disclosure.

Each of the gas turbine engines of FIGS. 6 through 9 generally include a rotor 502 rotatable about a rotor axis 504 and a turbomachine 506 rotatable about a longitudinal axis 508. The rotor 502 corresponds to the “primary fan” described herein. The turbomachine 506 is surrounded at least in part by a core cowl 510 and includes a compressor section 512, a combustion section 514, and a turbine section 516 in serial flow order. In addition to the rotor 502, the gas turbine engines of FIGS. 7 through 9 each also include a ducted mid-fan or secondary fan 518. The gas turbine engines each include a fan cowl 520 surrounding the secondary fan 518.

Referring still to the gas turbine engines of FIGS. 6 through 9, the gas turbine engines each also define a bypass passage 522 downstream of the respective rotor 502 and over the respective fan cowl 520 and core cowl 510, and further define a third stream 524 extending from a location downstream of the respective secondary fan 518 to the respective bypass passage 522 (at least in the embodiments depicted; in other embodiments, the third stream 524 may instead extend to a location downstream of the bypass passage 522).

Referring particularly to FIG. 6, the exemplary gas turbine engine depicted is configured as a turboprop engine 526. In such a manner, the rotor 502 (or primary fan) is configured as a propeller, defining a relatively large diameter. Further, the turboprop engine 526 includes an engine shaft 528 driven by the turbomachine 506, a fan shaft 530 rotatable with the rotor 502, and a gearbox 532 mechanically coupling the engine shaft 528 with the fan shaft 530. The gearbox 532 is an offset gearbox such that the rotor axis 504 is radially offset from the longitudinal axis 508 of the turboprop engine 526.

Notably, in other embodiments of the present disclosure, a turboprop engine may be provided with a reverse flow combustor.

Referring to FIGS. 7 through 9, the gas turbine engines are each configured as turbofan engines, and more specifically as ducted turbofan engines. In such a manner, the gas turbine engines each include an outer nacelle 534 surrounding the rotor 502, and the rotor 502 (or primary fan) of each is therefore configured as a ducted fan. Further, each of the gas turbine engines includes outlet guide vanes 536 extending through the bypass passage 522 to the outer nacelle 534 from the fan cowl 520, the core cowl 510, or both.

More specifically, still, the gas turbine engine of FIG. 7 is configured as a direct drive, ducted, turbofan engine 538. In particular, the direct drive, ducted, turbofan engine 538 includes an engine shaft 540 driven by the turbine section 516 and a fan shaft 542 rotatable with the rotor 502. The fan shaft 542 is configured to rotate directly with (i.e., at the same speed as) the engine shaft 540.

By contrast, the gas turbine engine of FIG. 8 is configured as a geared, ducted, turbofan engine 544. In particular, the geared, ducted, turbofan engine 544 includes the engine shaft 540 driven by the turbine section 516 and the fan shaft 542 rotatable with the rotor 502. However, the exemplary geared, ducted, turbofan engine 544 further includes a gearbox 546 mechanically coupling the engine shaft 540 to the fan shaft 542. The gearbox 546 allows the rotor 502 to rotate at a slower speed than the engine shaft 540, and thus at a slower speed than the secondary fan 518.

Notably, the exemplary geared, ducted, turbofan engine 544 of FIG. 8 further includes a pitch change mechanism 548 operable with the rotor 502 to change a pitch of the rotor blades of the rotor 502. Such may allow for an increased efficiency of the gas turbine engine.

Further, the exemplary gas turbine engine of FIG. 9 is again configured as a direct drive, ducted, turbofan engine 538. However, by contrast to the embodiment of FIG. 8 where a fan duct outlet defined by the fan duct is upstream of a bypass passage outlet defined by the bypass passage, in the embodiment of FIG. 9, the fan duct outlet defined by the fan duct is downstream of the bypass passage outlet defined by the bypass passage.

Moreover, in other exemplary embodiments, other suitable gas turbine engines may be provided. For example, referring now to FIG. 10, a gas turbine engine in accordance with yet another exemplary embodiment of the present disclosure is provided. The exemplary gas turbine engine of FIG. 10 may be configured in a similar manner as the exemplary gas turbine engines described above with reference to FIGS. 7 and 8.

For example, the exemplary gas turbine engine of FIG. 10 includes a rotor 502 rotatable about a rotor axis 504 and a turbomachine 506 rotatable about a longitudinal axis 508. The rotor axis 504 and the longitudinal axis 508 are aligned in the embodiment of FIG. 10. The rotor 502 corresponds to the “primary fan” described herein. The turbomachine 506 is surrounded at least in part by a core cowl 510 and includes a compressor section 512 (and, not shown, a combustion section and a turbine section in serial flow order with the compressor section 512). In addition to the rotor 502, the gas turbine engine also includes a ducted mid-fan or secondary fan 518 and a fan cowl 520 surrounding the secondary fan 518.

However, for the embodiment of FIG. 10, the gas turbine engine is configured as an unducted gas turbine engine 550 (see, e.g., FIG. 1), and the secondary fan 518 is not configured as a single stage fan (see fan 184 of FIG. 1). Instead, for the embodiment of FIG. 10, the secondary fan 518 is configured as a multi-stage secondary fan, and more specifically still as a two-stage secondary fan having a total of two stages of rotating compressor rotor blades, and more specifically having a first stage 552 of secondary fan rotor blades and a second stage 554 of secondary fan rotor blades. Notably, with such a configuration, the turbomachine 506 does not include a separate low pressure compressor.

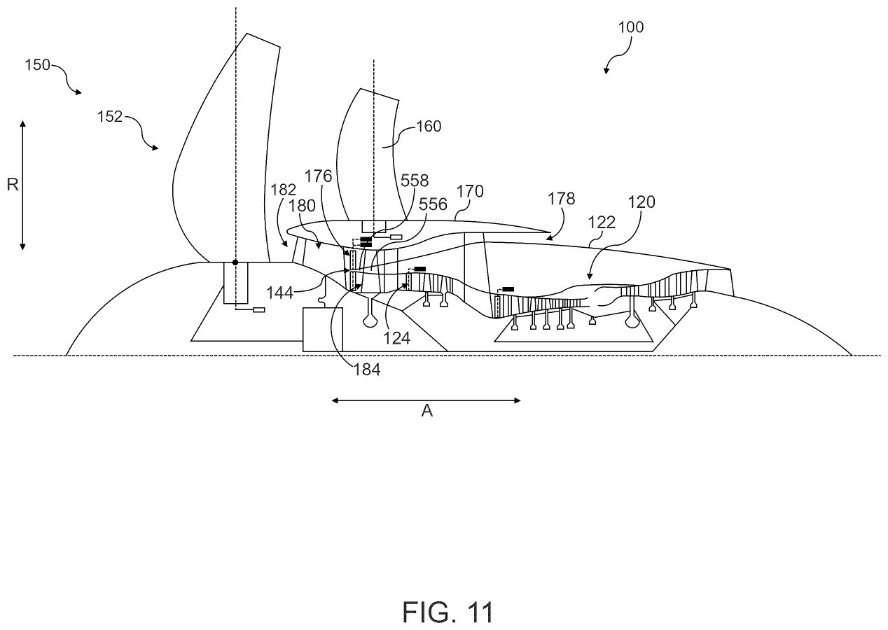

Additionally, in still other exemplary embodiments, the gas turbine engine may have other configurations. For example, referring now to FIG. 11, a gas turbine engine in accordance with yet another exemplary embodiment of the present disclosure is provided. The exemplary gas turbine engine of FIG. 11 may be configured in a similar manner as the exemplary gas turbine engines described above with reference to, e.g., FIGS. 1 through 3.

For example, the exemplary gas turbine engine of FIG. 11 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

The engine 100 also defines an inlet duct 180. The inlet duct 180 extends between an engine inlet 182 and a core inlet 124. The engine inlet 182 is defined generally at the forward end of the fan cowl 170 and is positioned between a fan 152 of the fan section 150 and a fan guide vane array 160 along the axial direction A. The engine 100 further includes a ducted fan 184 with a plurality of fan blades located at least partially in the inlet duct 180.

However, for the embodiment of FIG. 10, the core cowl 122 carries forward to an aft edge of the fan blades of the ducted fan 184 and the fan blades themselves include an integral splitter 556. This may be termed a blade-on-blade configuration where inner and outer blades are effectively superimposed upon one another and may be unitarily formed or otherwise fabricated to achieve the split between streams.

The core cowl 122 further includes a section 558 extending forward past the fan blades of the ducted fan 184, such that the leading edge 144 is located forward of the fan blades of the ducted fan 184. With such an arrangement, the fan duct inlet 176 is also located forward of the fan blades of the ducted fan 184, and an outer portion of the fan blades along the radial direction R is positioned within the fan duct 172. With this configuration, a secondary fan outer fan area, A_{S_Out}, may be calculated at the fan duct inlet 176 in the same manner discussed above with reference to, e.g., FIGS. 2 and 3.

Further, with such a configuration, the secondary fan inner fan area, A_{S_In}, still refers to an area defined by an annulus representing a portion of the ducted fan 184 located inward of the leading edge 144 of the core cowl 122. However, a calculation of the secondary fan inner fan area, A_{S_In}, is based on a leading edge radius, R₇, of the leading edge 144 and an inner fan duct radius, defined along the radial direction R, directly inward along the radial direction R from the leading edge 144 (and not a core inlet inner radius at the core inlet 124).

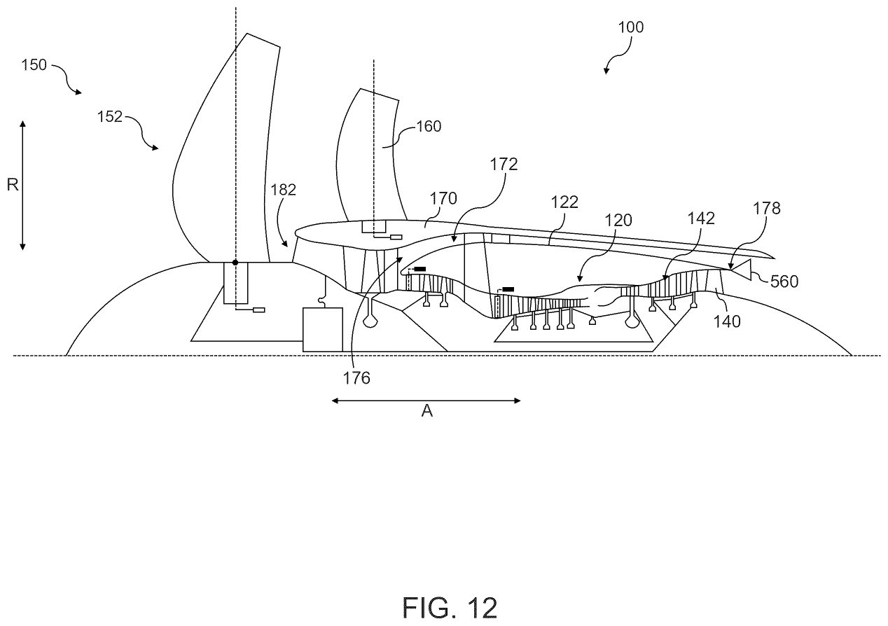

Further, still, in other exemplary embodiments, other engine configurations may be provided. For example, referring now to FIG. 12, an engine 100 in accordance with another embodiment of the present disclosure is provided. The engine 100 of FIG. 12 may be configured in a similar manner as the exemplary engine 100 of, e.g., FIGS. 1 through 3.

For example, the exemplary gas turbine engine of FIG. 12 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

However, for the embodiment of FIG. 12, the fan duct 172 of the exemplary engine 100 is an elongated fan duct 172 extending between the fan cowl 170 and the core cowl 122, a full length of the core cowl 122. With such a configuration, the fan exhaust nozzle 178 is downstream of an exhaust nozzle 140 of the turbomachine 120. The engine 100 of FIG. 12 further includes a mixing device 560 in the region aft of the exhaust nozzle 140 to aid in mixing airflow from the fan duct 172 and from a working gas flowpath 142 of the turbomachine 120, e.g., to improve acoustic performance by directing airflow from the working gas flowpath 142 of the turbomachine 120 outward and from the fan duct 172 inward. Mixing in such a manner may improve performance and noise emissions.

Moreover, in other exemplary embodiments of the present disclosure, a gas turbine engine may have still other suitable configurations. For example, in other embodiments, the gas turbine engine may include any suitable number of shafts or spools, compressors, or turbines (e.g., the gas turbine engine may be a three-spool engine having three turbines and associated spools).

Further, it will be appreciated that in at least certain exemplary embodiments of the present disclosure, a method of operating a gas turbine engine is provided. The method may be utilized with one or more of the exemplary gas turbine engines discussed herein, such as in FIGS. 1 through 12. The method includes operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5. For the exemplary method, the thrust to power airflow ratio is a ratio of an airflow through a bypass passage over a turbomachine of the gas turbine engine plus an airflow through a fan duct to an airflow through a core duct, and the core bypass ratio is a ratio of the airflow through the fan duct to the airflow through the core duct.

As will be appreciated from the description herein, various embodiments of a gas turbine engine are provided. Certain of these embodiments may be an unducted, single rotor gas turbine engine (see FIGS. 1 and 2, 11, and 12), a turboprop engine (see FIG. 6), or a ducted turbofan engine (see FIGS. 7 through 9). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the figures.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.0 to 4.5, 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In some embodiments, the L/Dcore is less than 5, less than 4, and less than 3. In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

As discussed above, in certain embodiments of a gas turbine engine, such as described herein, a variable pitch fan can be provided in the engine 100. Generally, the pitch of the fan blades 154 varies between a number of pitch positions such that the fan blades 154 traverse a range of pitches. A certain pitch range may be required to accommodate the various pitch positions associated with different phases of flight and/or optimal performance of the gas turbine engine 100. However, the pitch range often is restricted by design parameters or considerations such as a solidity of the fan blades 154 and the configuration of various components of the fan 152, such as counterweights, trunnion mechanisms, and pitch change actuator assemblies. The solidity of the fan blade 154 represents a ratio of blade chord length (width) to spacing between blades.

Airflow and bypass can be affected significantly by fan blade pitch changes, or limitations on the pitch variance capability of the fan. Higher bypass necessitates more variability in and a wider range of pitch to handle variability in operability, thrust, and speed resulting from the higher bypass ratio. Additionally, increased solidity at the root helps get air core of the engine. As described above, the variable pitch fan 152 impacts TPAR and CBR. Inclusion of a variable pitch primary fan may allow for a larger fan, but may also necessitate higher heat rejection abilities for the gas turbine engine 100, which may, in turn increase a CBR. The inventors have developed a smaller variable pitch fan that can generate a large amount of thrust. Particularly, exemplary embodiments provide a gas turbine engine with a variable pitch fan having, e.g., a larger pitch range, a higher blade count, a lower/shorter blade length, a lower hub to fan radius ratio, a lower fan pressure ratio, and/or an increased solidity in a root region of the blades. Such can increase the fan's efficiency, which, e.g., can decrease the fuel burn during operation and can otherwise improve the engine's performance.

Accordingly, a variable pitch fan 152 for a propulsion device having features to enable a larger pitch range with optimal design parameters is desirable. In particular, a variable pitch fan 152 having a plurality of fan blades 154 where a pitch of the fan blades 154 may be varied over an increased pitch range and having an increased solidity in a root region of the fan blades 154 is beneficial. A variable pitch fan 152 having a plurality of fan blades 154 where a pitch of the fan blades 154 may be varied over an increased pitch range and having a decreased fan hub radius ratio and/or a decreased fan pressure ratio also is advantageous.

With a variable pitch fan 152, it is desirable to vary the pitch of the fan blades 154 by rotating each blade about respective pitch axes to further increase performance of the propulsion device during different operating ranges. For example, a primary reason for changing blade pitch is to adjust the blade's angle of attack for optimal performance based on the present air speed of the aircraft and power level of the engine 100. In addition, the pitch of fan blades 154 may be used to reverse the airflow through the fan 152, thus providing reverse thrust to aerodynamically brake a landing aircraft.

Variable pitch fans 152 require a certain range of angular movement during forward flight and reverse flight. That is, variable pitch fans 152 must travel a certain range to optimize performance at various conditions. The range is restricted by hub solidity, counterweights, trunnion bearings, and pitch change actuators setting a fan hub radius ratio. The use of remote counterweights or no counterweights, and a fan hub solidity greater than 1 drives one to go to reverse through stall, not flat pitch. This has a given angular range associated with it of about 130 degrees.

In certain exemplary embodiments, the fan 152 is a variable pitch fan 152. The variable pitch fan 152 includes a plurality of fan blades 154 coupled to a disk and a rotatable front hub covering the disk. Each fan blade of the plurality of fan blades extends radially outward from the disk, and each fan blade extends along a span from a root to a tip. A portion of the span adjacent the root defines a root span region, and a portion of the span adjacent the tip defines a tip span region.

Although described herein with respect to gas turbine engine 100, it should be understood that the present disclosure applies equally to both ducted and unducted configurations of variable pitch fans of turbofan engines. Variable pitch is important in unducted fans to ensure a proper angle of incidence, for example. In ducted engines, variable pitch can help to control speed, thrust, etc., without reducing speed. Additionally, in still other exemplary embodiments, aspects of the present disclosure may be incorporated into other propulsion devices, such as an electrically powered fan engine, ducted or unducted.

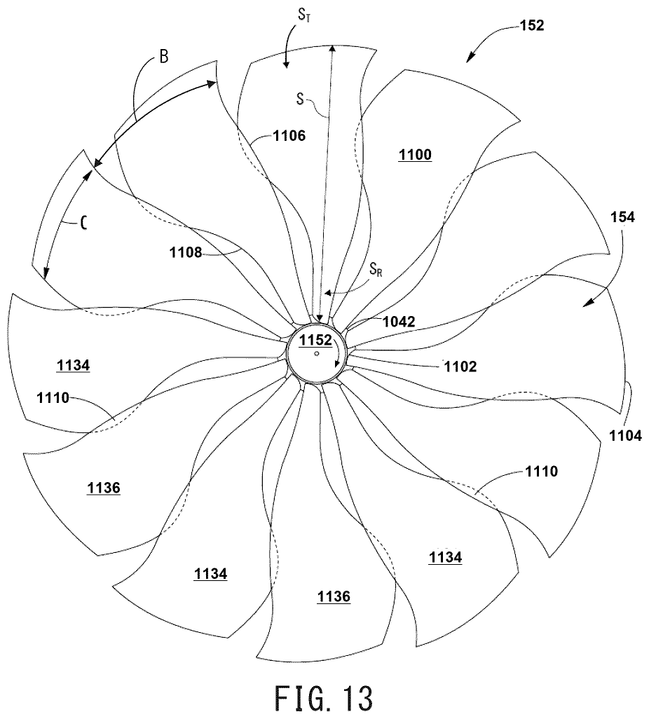

Referring now to FIG. 13, a schematic, close-up view of the gas turbine engine 100 is depicted in accordance with another exemplary embodiment of the present disclosure. The exemplary embodiment of FIG. 13 may be configured in substantially the same manner as the exemplary gas turbine engine 100 described above with reference to, e.g., FIGS. 1 and 2.

An example implementation of the fan 152 is shown and described in greater detail in connection with FIG. 13. FIG. 13 provides a forward-facing-aft elevational view of fan 152 of the exemplary turbofan engine 100 of FIGS. 1 and 2. For the depicted exemplary embodiment, fan 152 includes twelve (12) fan blades 154. From a loading standpoint, such a blade count enables the span of each fan blade 154 to be reduced such that the overall diameter of fan 152 is also able to be reduced (e.g., to about twelve feet in the exemplary embodiment). That said, in other embodiments, fan 38 may have any suitable blade count and any suitable diameter. For example, in one suitable embodiment, fan 152 may have at least ten (10) fan blades 154. In another suitable embodiment, fan 152 may have at least eleven (11) fan blades 154. In yet another suitable embodiment, fan 152 may have at least twelve (12) fan blades 154. In yet other suitable embodiments, fan 152 may have at least fifteen (15) or at least eighteen (18) fan blades 154.

In certain embodiments, a solidity of the variable pitch fan 152 is at least 1.0 in the root span region. In certain embodiments, a fan pressure ratio of the variable pitch fan 152 is less than about 1.5. The fan pressure ratio is the ratio of the fan outlet or discharge pressure to the fan inlet pressure. A fan pressure ratio below about 1.5 allows improved mechanical and propulsive efficiency. In an exemplary embodiment, the fan pressure ratio may be about 1.4; in another suitable embodiment, the fan pressure ratio may be about 1.2. However, the fan pressure ratio also may have other values below or less than about 1.5.

In certain embodiments, a fan hub radius ratio of the variable pitch fan 152 is less than about 0.40. Further, each fan blade 154 is rotatable about a pitch axis to vary a pitch of the fan blade 154, and the pitch axis extending radially through the fan blade 154. The pitch is variable within a pitch range, and the pitch range is at least about 80° to about 130°.

As described above, the fan hub radius ratio previously mentioned is a ratio of a radius R₁ over a radius R₂. Radius R₁ is a radius of a rotatable hub along the radial direction R from the longitudinal centerline 112 at the leading edge of the blades 154. Radius R₂ is a radius of the blades 154 from the blade tips to the longitudinal centerline 112 also at the leading edge of the blades 154. For a given R₂, reducing R₁ increases a fan frontal flow area, which reduces a fan pressure ratio for a given thrust, which improves fan aerodynamic efficiency. Alternatively, for a given fan frontal flow area and associated fan aerodynamic efficiency, reducing R₁ decreases R₂, which reduces the size and weight of the fan. Accordingly, reducing the fan hub radius ratio can improve the performance or size and weight of the engine. Further, reducing R₁ reduces the curvature experienced by the airflow over the rotatable hub into the core of the engine 100, which reduces loss penalties.

As will be described in greater detail below, certain embodiments of the present disclosure allow for such a reduction in fan hub radius ratio by reducing a weight of certain components of fan 38 (e.g., certain bearings, discussed below), which generate less centrifugal force and permit smaller and more compact components that are not required to withstand heightened centrifugal forces. More particularly, in the depicted exemplary embodiment, the fan hub radius ratio for turbofan engine 10 has been reduced to less than or equal to about 0.40. However, in other exemplary embodiments, the fan hub radius ratio may instead be less than or equal to about 0.35, less than or equal to about 0.30, or alternatively, fan 38 may have any other suitable fan hub radius ratio. It should be appreciated that, as used herein, terms of approximation, such as “about,” refer to being within a ten percent (10%) margin of error.

Each fan blade 154 has an aerodynamic profile including a generally concave pressure side and a circumferentially opposite, generally convex suction side 1100. Each fan blade 154 extends radially along a span S from an inner root 1102, which is rotatably coupled to disk 1042, to a radially outer distal tip 1104 disposed closely adjacent to a fan casing or nacelle to provide a relatively small tip clearance or gap therebetween. That is, root 1102 is the radially innermost portion of fan blade 154, and tip 1104 is the radially outermost portion of fan blade 154. Further, each fan blade 154 is rotatable about a pitch axis P with respect to disk 1042; each pitch axis P generally extends radially through its respective fan blade 154.

Variable pitch fans, such as the fan 152, traverse a range of pitch or angular positions during forward flight and reverse, e.g., fan blades 154 rotate with respect to pitch axis P to vary the pitch of fan blades over an angular range corresponding to various pitch positions. For example, fan blades 154 may have a pitch position with respect to pitch axis P during a cruise phase of forward flight and a different pitch position with respect to pitch axis P during a takeoff phase. Further, these pitch positions or pitch angles of fan blades 154 may be different than a pitch position during a reverse thrust phase.

Typically, between pitch positions for different phases of forward flight and reverse thrust, the extent of angular movement of fan blades 154 is at least about 80° (e.g., approximately 120°, 130°, etc.). That is, a pitch range of at least about 80° (e.g., approximately 120°, 130°, etc.) separates two extreme pitch positions, with other pitch positions between those two. Thus, the fan blades 154 should be able to traverse a pitch range between approximately 80° and approximately 130°.

As an example, the two pitch positions separated by the pitch range are a coarse/feather pitch position and a reverse pitch position, such as between a pitch of fan blades 154 for a coarse/feather phase and a pitch of fan blades 154 for a reverse thrust phase. In some embodiments, the pitch range may be about 80°; that is, fan blades 154 traverse approximately 80° in transitioning from one extreme pitch position to the other during phases of forward flight and reverse thrust. In alternative embodiments, the pitch range may be about 120°; that is, fan blades 154 traverse approximately 120° in transitioning from one extreme pitch position to the other during phases of forward flight and reverse thrust. In still other suitable embodiments, the pitch range may be about 90°, about 100°, about 110°, or about 130°. Thus, in suitable embodiments of the present disclosure, the pitch of fan blades 154 is variable within a pitch range, where the pitch range is between about 80° to about 130°, but other pitch ranges (e.g., less than about 80° or more than about 130°) may be used as well.

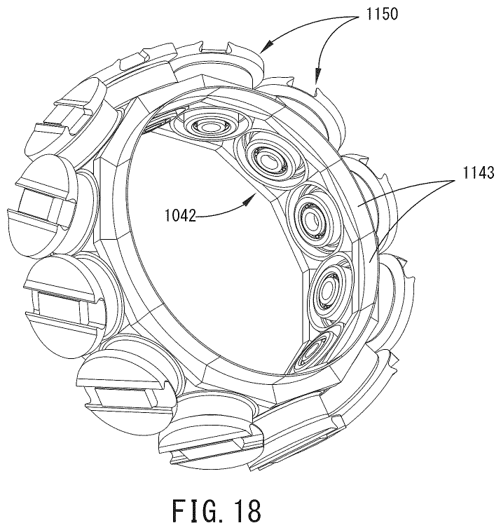

Although a pitch range of at least about 80°, and preferably about 120° or 130°, generally is required to accommodate the various pitch angles of fan blades 154 of the variable pitch fan 152, other design features or considerations may interfere with or restrict the pitch range of the blades 154. For example, a desired solidity of the fan 152, further described below, may dictate a lower or smaller pitch range. That is, to achieve a desired solidity value, variations in the pitch of fan blades 154 may be limited such that the pitch range is less than about 80°. As other examples, the configuration of counterweights, trunnion mechanisms, and/or pitch change actuator assemblies, as well as other components of the fan section 150, may restrict the range of pitch or angular positions fan blades 154 are able to traverse. Accordingly, the fan 152 may utilize one or more features described herein, such as, e.g., actuator assembly 158 and/or a trunnion mechanism 1150 (e.g., shown and described with respect to FIG. 18), to achieve a pitch range of at least about 80° (e.g., approximately 120° or) 130°.

As shown in FIG. 13, each fan blade 154 defines a chord length C that extends between opposite leading edge 1106 and trailing edge 1108. Chord length C may vary over span S of fan blade 154. In some embodiments, chord length C may be longer or greater in a root region of span S, to enable a higher lift in the root region of the fan 152. The higher lift may be desired to increase the fan pressure ratio in the root region and thereby maintain supercharging at the core, although the overall fan pressure ratio of the fan 152 may be maintained below about 1.5 as described above.

Referring still to FIG. 13, a portion of span S adjacent root 1102 may define a root span region SR and a portion of span S adjacent tip 1104 may define a tip span region ST. Root 1102 may be designated a zero span location, i.e., span S begins at root 1102 such that root 1102 is at zero span or zero percent of span S. Tip 1104 may be designated a full span location, i.e., span S ends at tip 1104 such that tip 1104 is at full span or one hundred percent (100%) of span S. Locations along the fan blade 154 between root 1102 and tip 1104 may be designated as fractions or percentages of span S, e.g., the midpoint of the fan blade 154 is at half span or fifty percent (50%) of span S. Accordingly, root span region SR may correspond to the portion of span S between zero span and a fraction or percentage of span S near the root 1102, and tip span region ST may correspond to the portion of span S between a fraction or percentage of span S near the tip 1104 and full span. As one example, root span region SR may extend from the root 1102 at zero span to about ten percent (10%) of span S, or as another example, root span region SR may extend from the root 1102 at zero span to about twenty percent (20%) of span S. Similarly, in some embodiments, tip span region ST may extend from about ninety percent (90%) of span S to the tip 1104 at full span or one hundred percent (100%) of span S, or in other embodiments, tip span region ST may extend from about eighty percent (80%) of span S to the tip 1104 at full span or one hundred percent (100%) of span S. Of course, root and tip span regions SR, ST also may correspond to other portions of span S adjacent root 1102 and tip 1104, respectively.

As stated above, the fan 152 has a corresponding solidity, which is a parameter equal to the ratio of the blade chord length C at a span location divided by the circumferential spacing B, or spacing from blade to blade, at the corresponding span location. Circumferential spacing B is equal to the circumferential distance around the fan at the specific radial span divided by the total number of fan blades in the blade row. Accordingly, the solidity is directly proportional to the number of blades and chord length and inversely proportional to the radial distance from the longitudinal axis or centerline 112. To optimize the performance of the variable pitch fan 152, the solidity of the fan 152 is at least 1.0, for example, in root span region SR. That is, the solidity of the fan 152 is at least 1.0 adjacent fan blade root 1102, e.g., along ten to twenty percent (10-20%) of blade span S or at each span location of root span region SR.

Typical high solidity turbofans have adjacent fan blades 154 that substantially overlap each other circumferentially due to the high solidity and high angle of the blade chord with respect to the axial direction, or stagger, of the airfoils. For example, as shown in FIG. 13, the fan blades 154 have high solidity and adjacent blades would contact each other when passing through a flat pitch position. Due to the solidity of the fan blades 154, it can be seen that the fan blades 154 would overlap at least in region 1110 if they pass through flat pitch at the same time. However, given the configuration shown in FIG. 13, unacceptable blade contact will occur if fan blades 154 rotate in unison through flat pitch. Accordingly, the solidity of the fan 152 may vary along span S of the fan blades 154 to enable the variation of the pitch of the fan blades 154 within the desired pitch range, e.g., a pitch range of about 80°, about 120°, or another desired pitch range. For example, the solidity of the fan 152 may be less than 1.0 in the tip span region ST to allow fan blades 154 to pass through each other to reverse thrust. In such embodiments, where the solidity in the root span region SR is at least 1.0 and the solidity in the tip span region ST is less than 1.0, tips 1104 of fan blades 154 may reverse fully but the roots 1102 may not.

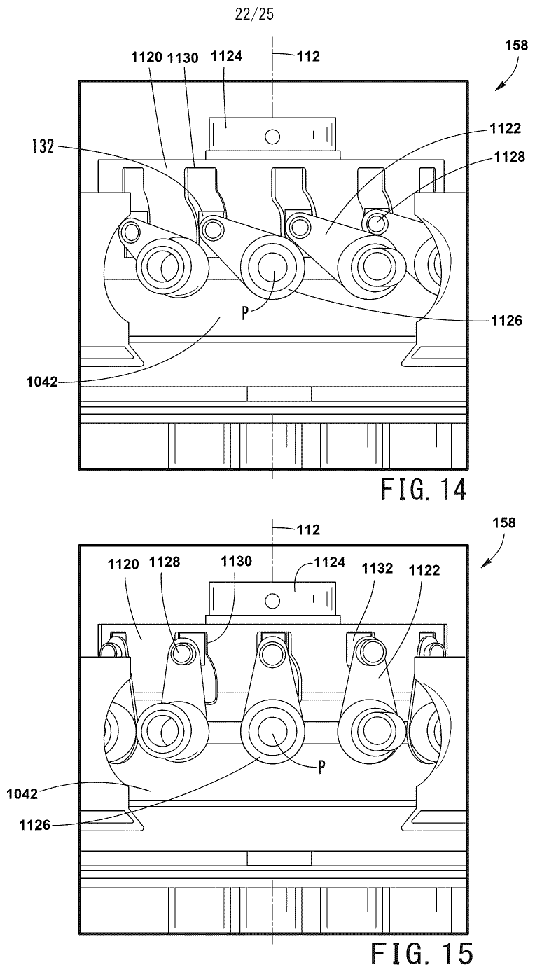

Alternatively or additionally, the fan 152 may be configured for asynchronous blade pitching as described below with respect to FIGS. 14 through 17. Such a system, i.e., asynchronous blade pitching, can ensure that fan blades 154 do not pass through flat pitch at the same time, as well as provide other performance-related improvements to the operation of the fan 152, as discussed below.

Referring now to FIGS. 14 and 15, a blade pitch change actuation assembly 158 in accordance with an exemplary embodiment of the present disclosure is depicted. As mentioned above, each fan blade 154 is rotatable relative to a disk 1042 about a pitch axis P. Fan blades 154, disk 1042, and actuation assembly 158 are together rotatable about the longitudinal axis 112 by LP shaft 138 across a power gear box 155.

The pitch change actuation assembly 158 generally includes a scheduling ring 1120, a plurality of linkage arms 1122, and an electric motor 1124. Each fan blade 154 may be rotatably coupled to the disk 1042 through a first end 1126 of a corresponding linkage arm 1122 such that the first end 1126 and the corresponding fan blade 154 can rotate about pitch axis P relative to disk 1042. In this regard, the fan blade 154 may be fixedly connected to first end 1126 of the corresponding linkage arm 1122, such that rotation of linkage arm 1122 causes the fan blade 154 to rotate relative to the disk 1042.

A second end 1128 of the linkage arm 1122 may be slidably connected to one of a plurality of slots 1130 defined in scheduling ring 1120. For example, the second end 1128 may be rotatably connected to a sliding member 1132. The sliding member 1132 may be slidably received in a slot 1130 of the scheduling ring 1120. The scheduling ring 1120 is rotatable about the longitudinal centerline 112 relative to the disk 1042 and is operatively coupled with an electric motor 1124, which is fixed relative to the disk 1042.

Each of the plurality of slots 1130 on the scheduling ring 1120 defines a blade pitch schedule. In this regard, for a given angle of rotation of the scheduling ring 1120, the blade pitch schedule determines the actual pitch angle of the fan blades 154. In operation, the electric motor 1124 rotates the scheduling ring 1120 relative to the disk 1042. As the scheduling ring 1120 rotates, the sliding member 1132 moves along the slot 1130 and the angular position of the linkage arm 1122 changes. As each linkage arm 1122 rotates, the corresponding fan blade 154 rotates as well, thus rotating each fan blade 154 about its pitch axis P. In alternative embodiments, one or more hydraulic actuators or any other suitable device or mechanism may be used in place of or in addition to the electric motor 1124 to rotate the scheduling ring 1120.

Therefore, by rotating the scheduling ring 1120 relative to the disk 1042, each of the plurality of fan blades 154 rotates about its respective pitch axis P according to a blade schedule defined by the slot 1130 to which it is coupled by the linkage arm 1122. By defining different blade pitch schedules, the rotation of fan blades 154 may be controlled independently of each other. Thus, for example, if alternating fan blades 154 are rotated according to different blade pitch scheduling, conflict through, e.g., flat pitch, may be avoided. In addition, the pitch schedule may be adjusted to improve performance of the fan blade 154.

The blade pitch schedules may depend, for example, on whether the aircraft is in a coarse/feather phase, a normal flight phase, a flat pitch transition phase, a reverse thrust configuration, or other flight phases. For example, the variable pitch fan 152 may be configured for normal flight phase when the fan blades 154 have a pitch of greater than 8°. In addition, when the fan blades 154 are within 8° of flat pitch (i.e., between −8° and 8°), the variable pitch fan 152 may be operating in a flat pitch transition phase. The fan blades 154 may be in a reverse thrust phase when angled at −8° or less. One skilled in the art will appreciate that these ranges are used only for the purpose of explanation and that phases and blade schedules may be defined in a variety of other ways to improve performance of the variable pitch fan 152 and the engine 100. Further, as previously described, the overall pitch range, i.e., the range of variation in pitch for all flight phases, may be about 80° in some embodiments, about 120° in other embodiments, and about 130° in still other embodiments, although the pitch range may have other values as well.

In an example embodiment, the plurality of fan blades 154 rotate according to different pitch schedules to avoid conflict as the fan blades 154 rotate through flat pitch. More specifically, as shown in FIG. 13, a first set of fan blades 1134 may rotate according to a first blade pitch schedule, and an alternating, second set of fan blades 1136 may rotate according to a second blade pitch schedule. The first and second blade pitch schedule may be the same for a first phase of rotation, which may correspond to normal flight operation, but the pitch schedules may deviate from one another as the fan blades 154 enter flat pitch. For example, as soon as the pitch of the plurality of fan blades 154 reach within 8° of flat pitch, the rotational speed of the first set of fan blades 1134 may increase while the rotational speed of the second set of fan blades 1136 may decrease. In this manner, the first set of blades 1134 may pass through flat pitch sequentially ahead of the second set of blades 1136, thus avoiding contact through flat pitch. After all fan blades 154 have passed through flat pitch and begin to generate reverse thrust, the first and second blade pitch schedules may once again sync up with each other so that all fan blades 154 rotate in unison. Alternatively, however, the blade schedules may remain offset to ensure reverse thrust is achieved without choking the air going to core of the engine 100 (the high pressure compressor 128, the combustor 130, and the high pressure turbine 132 may collectively be referred to as the “core” of the engine 100) and/or to achieve other performance improvements.

One skilled in the art will appreciate that the blade pitch schedules discussed above are only exemplary, and that any other blade pitch schedule or schedules may be used as needed for performance. For example, more than two blade pitch schedules may be used. Indeed, every fan blade 154 could rotate according to its own pitch schedule. All such variations are contemplated as within the scope of the present disclosure.

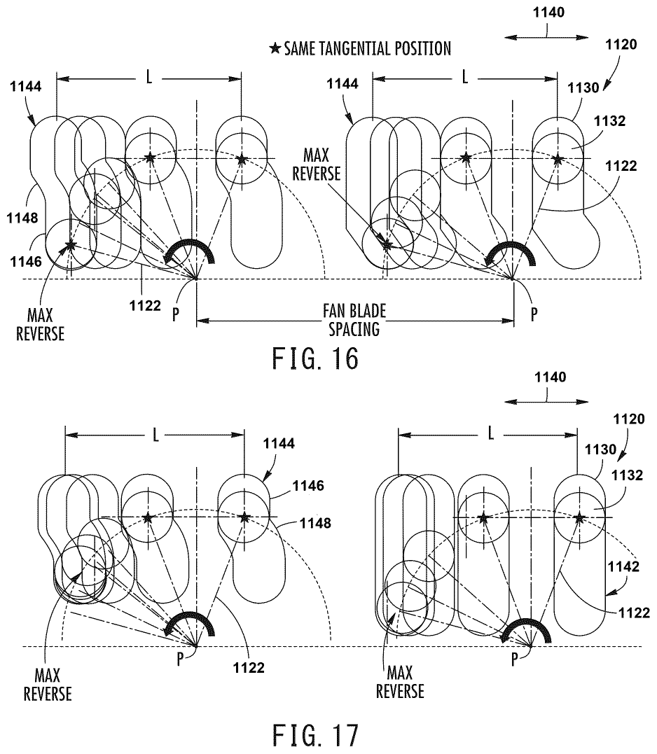

Now referring to FIGS. 16 and 17, a schematic representation of the displacement of the sliding member 1132 is shown. This representation depicts two adjacent fan blades 154 rotating according to blade schedules defined by scheduling slots 1130 in the scheduling ring 1120. In the illustrated embodiment of FIGS. 16 and 17, each fan blade 154 is centered about its respective pitch axis P, where it is rotatably coupled to the disk 1042. Each linkage arm 1122 is schematically represented by dotted line 1122 and rotates a fixed radial distance about its respective pitch axis P. Sliding member 1132 is rotatably connected to the linkage arm 1122 and is slidably coupled to the scheduling slot 1130.

As shown in the figures, as the scheduling ring 1120 rotates relative to the disk 1042, scheduling slots 1130 generally are translated in the direction indicated by an arrow 1140. For each angular position of the scheduling ring 1120, the angular position of each fan blade 154 may be varied according to the shape of its respective scheduling slot 1130. For example, referring specifically to FIG. 17, some scheduling slots 1130 may be entirely linear (e.g., linear scheduling slot 1142). By contrast, some scheduling slots 1130 may be non-linear (e.g., non-linear scheduling slot 1144), for example, by having one or more linear portions 1146 and one or more bent portions 1148. In other embodiments, scheduling slots 1130 may be curved, serpentine, or any other suitable shape.

Notably, when the scheduling ring 1120 is rotated at a constant velocity, a linkage arm 1122 connected to the entirely linear scheduling slot 1142 will have a constant rotational speed function about pitch axis P. By contrast, the rotational speed of a linkage arm 1122 connected to a non-linear slot will vary according to the shape of its respective scheduling slot 1130. In this manner, by alternately shaping each scheduling slot 1130, alternating fan blades 154 may rotate into flat pitch at different times, such that fan blade 154 contact will not occur through flat pitch. In addition, adjacent scheduling slots 1130 may have a similar profile throughout the pitch range of the fan blade 154, such that fan blades 154 rotate in unison throughout their range with the exception of the point where the blades 154 enter flat pitch.

One skilled in the art will appreciate that the above-described mechanism for actuating the rotation of the fan blades is only one exemplary mechanism for achieving asynchronous fan blade pitching. Other mechanisms will be evident to a skilled artisan based on the present disclosure. Any such variations or modifications are contemplated as within the scope of the present disclosure. Further, in some embodiments, the desired pitch range of fan blades 40 may be achieved without requiring asynchronous fan blade pitching. For example, as described in more detail herein, the mechanism used to attach fan blades 154 to the disk 1042 may be configured such that a pitch range of at least about 80°, and more specifically at least about 120° or 130°, is possible. In such embodiments, other suitable pitch change actuation assemblies or mechanisms may be used to vary the pitch of fan blades 154.

The above-described embodiments enable thrust reverse for a variable pitch fan 152 with the fan blade 154 solidity greater than one without a need for a heavy thrust reverse mechanism. Particularly, the proposed fan blade 154 pitch change mechanism enables 2-phase asynchronous fan blade 154 pitching, such that at least circumferentially adjacent fan blades 154 rotate on a different schedule through flat pitch and/or reverse, which allows fan blades 154 to pass each other without contact. For example, the pitch change mechanism or actuator assembly can rotate six out of twelve fan blades 154 on a different schedule through reverse, thus allowing reverse thrust to be achieved without contact between fan blades 154 as they pass through flat pitch. All fan blades 154 may rotate on the same schedule throughout the entire flight envelope with the exception of the reverse condition. Benefits of asynchronous fan blade 154 pitching include improvements in engine efficiency and specific fuel consumption. Installation is also simplified as compared to prior designs, fan operability is improved, and stall margin is increased.

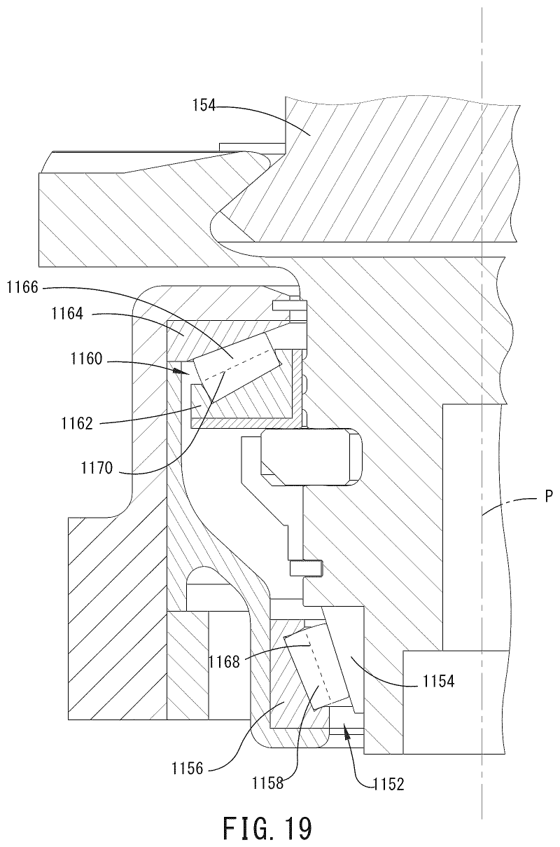

Referring now to FIGS. 18 and 19, an attachment mechanism enabling a pitch range of at least about 80°, and preferably about 120° or 130°, is shown. As shown in FIG. 18, the disk 1042 includes a plurality of disk segments 1143 that are rigidly coupled together or integrally molded together in a generally annular shape (e.g., a polygonal shape). One fan blade 154 is coupled to each disk segment 1143 at a trunnion mechanism 1150 that facilitates retaining its associated fan blade 154 on the disk 1042 during rotation of the disk 1042 (i.e., the trunnion mechanism 1150 facilitates providing a load path to the disk 1042 for the centrifugal load generated by fan blades 154 during rotation about longitudinal centerline axis 112), while still rendering its associated fan blade 154 rotatable relative to the disk 1042 about pitch axis P. Notably, the size and configuration of each trunnion mechanism 1150 directly influences the diameter of the disk 1042. On the one hand, larger trunnion mechanisms 1150 tend to occupy larger circumferential segments of the disk 1042 and, hence, tend to result in a larger diameter of the disk 1042. On the other hand, smaller trunnion mechanisms 1150 tend to occupy smaller circumferential segments of the disk 1042 and, hence, tend to result in a smaller diameter of disk 1042.

Referring now to FIG. 19, a partial cross-section of an individual disk segment 1143 and trunnion mechanism 1150 in accordance with an exemplary embodiment of the present disclosure are depicted. In the illustrated embodiment, each trunnion mechanism 1150 extends through its associated disk segment 1143 and includes a first line contact bearing 1152 having, e.g., an inner race 1154, an outer race 1156, and a plurality of rollers 1158; and a second line contact bearing 1160 having, e.g., an inner race 1162, an outer race 1164, and a plurality of rollers 1166. For use as bearings 1152, 1160, at least the following types of line contacting type rolling element bearings are contemplated: cylindrical roller bearings; cylindrical roller thrust bearings; tapered roller bearings; spherical roller bearings; spherical roller thrust bearings; needle roller bearings; and tapered roller needle bearings. It should be appreciated, however, that in other exemplary embodiments, the trunnion mechanism 1150 may additionally or alternatively include any other suitable type of bearing. For example, in other exemplary embodiments, the trunnion mechanism 1150 may include roller ball bearings or any other suitable bearing.

In the depicted exemplary embodiment, the first line contact bearing 1152 is oriented at a different angle than the second line contact bearing 1160 (as measured from a centerline axis 1168 of rollers 1158 relative to pitch axis P, and from a centerline axis 1170 of rollers 1166 relative to pitch axis P). More specifically, line contact bearings 1152, 1160 are preloaded against one another in a face-to-face (or duplex) arrangement, wherein centerline axes 1168, 1170 are oriented substantially perpendicular to one another. It should be appreciated, however, that in other exemplary embodiments, line contact bearings 1152, 1160 may instead be arranged in tandem so as to be oriented substantially parallel to one another.

Notably, the farther away the bearings 1152, 1160 are from pitch axis P, the greater the number of rollers 1158, 1166 that can be included (due to the greater amount of room). With an increased number of rollers 1158, 1166, a centrifugal load on bearings 1152, 1160 may be distributed amongst more rollers 1158, 1166, reducing an amount of such load borne by each individual roller 1158, 1166. However, to facilitate making the trunnion mechanism 1150 more compact, it is desirable to locate its associated bearings 1152, 1160 closer to pitch axis P, thereby enabling more trunnion mechanisms 1150 to be assembled on the disk 1042 and, hence, more fan blades 40 to be coupled to the disk 1042 for any given diameter of disk 1042. For the depicted embodiment, the increased centrifugal loads borne by each individual roller 1158, 1166 due to the placement of bearings 1152, 1160 closer to pitch axis P (and, thus, a reduced number of rollers 1158, 1166) are accommodated by providing the trunnion mechanism 1150 with line contact bearings 1152, 1160, as opposed to angular point contact ball bearings. Thus, the trunnion mechanism 1150 is able to be made more compact because line contact bearings 1152, 1160 are better able to withstand larger centrifugal loads without fracturing or plastically deforming. More specifically, line contact bearings 1152, 1160 have larger contact surfaces and, therefore, can withstand larger centrifugal loads than, e.g., point contact ball bearings. Thus, line contact bearings 1152, 1160 can be spaced closer to pitch axis P than point contact ball bearings.

Further, for the depicted exemplary embodiment, an amount of centrifugal force generated by trunnion mechanisms 1510 themselves (and, thus, an amount of centrifugal force that must be accommodated by trunnion mechanisms 1150) is reduced by forming one or more components of the first line contact bearing 1152 and/or second line contact bearing 1160 of a nonferrous material. Such a configuration may reduce a weight/mass of the respective bearings 1152, 1160 and of the trunnion mechanism 1150 as a whole.

For example, in certain exemplary embodiments of the present disclosure, one or both of the first line contact bearing 1152 and the second line contact bearing 1160 may include one or more components including or otherwise formed of a ceramic material or a nickel titanium alloy material. More particularly, with reference to the first line contact bearing 1152, one or more of the rollers 1158, inner race 1154, or outer race 1156 may include a nonferrous material, such as a ceramic material or a nickel titanium alloy material. Additionally, with reference to the second line contact bearing 1160, one or more of the rollers 1166, inner race 1162, or outer race 1164 may also include a nonferrous material, such as a ceramic material or a nickel titanium alloy material. As used herein, “ceramic material” refers to any type of ceramic material suitable for use in bearings, including, but not limited to, silicone nitride (Si3N4), zirconia oxide (ZrO2), alumina oxide (Al2O3), and silicon carbide (SiC). Additionally, as used herein, “nickel titanium alloy material” refers to any metal alloys of nickel and titanium, sometimes referred to as nitinol, suitable for use in bearings.

By forming one or more of the components of the first line contact bearing 1152 and/or the second line contact bearing 1160 of a nonferrous material, such as a ceramic material or nickel titanium alloy material, trunnion mechanisms 1150 may define a reduced overall weight. Thus, the centrifugal forces on trunnion mechanisms 1150 generated by trunnion mechanisms 1150 themselves (i.e., a “dead load”) during rotation of fan 152 about the longitudinal centerline 112 may be reduced (as such trunnion mechanisms 1150 are not having to support the additional weight during operation). For example, in certain exemplary embodiments, forming one or more of the components of the first line contact bearing 1152 and/or the second line contact bearing 1160 of a nonferrous material can reduce a dead load on trunnion mechanisms 1150 during rotation of the fan 152 by as much as ten percent (10%) or fifteen percent (15%). Accordingly, the overall size of trunnion mechanisms 1150 may be reduced even further. More particularly, such a configuration may allow bearings 1152, 1160 to be positioned even closer to pitch axis P (as fewer rollers are required), further reducing the size of trunnion mechanisms 1150. Thus, such bearings are, e.g., better able to withstand increased centrifugal loads associated with higher blade counts and/or able to be reduced in size to accommodate a reduction in the hub to fan radius ratio.

Additionally, or alternatively, in certain exemplary embodiments, one or more of the components of the first line contact bearing 1152 and/or the second line contact bearing 1160, such as one or more of the rollers 1158, 1166, inner races 1154, 1162, or outer races 1156, 1164 of the first and second line contact bearings 1152, 1160, respectively, may include material having a relatively low Young's modulus, such as a Young's modulus less than or equal to about 25 megapounds per square inch (Mpsi). For example, in certain exemplary embodiments, one or more of the above components of the first and/or second line contact bearings 1152, 1160 may include material having a Young's modulus less than or equal to about 20 Mpsi, less than or equal to about 17 Mpsi, less than or equal to about 15 Mpsi, or less than or equal to about 14 Mpsi. Such an exemplary embodiment may allow the respective components to withstand an increased amount of force, such as an increased amount of centrifugal force, as such components may elastically deform during rotation of the fan 152. For example, when a component undergoes an elastic deformation, an increased contact surface area may be defined between the component and an adjacent component. For example, in certain embodiments wherein rollers 1158 of first line contact bearing 1152 are comprised of a material having a relatively low Young's modulus, rollers 1158 may at least partially elastically deform during operation, such that an increased contact surface area is defined between, e.g., rollers 1158 and inner race 1154 and/or outer race 1156, allowing for a greater distribution of force between the components.

By contrast, however, in other exemplary embodiments, one or more of the components of the first line contact bearing and/or the second line contact bearing 1252, 1260 may instead include material having a relatively high Young's modulus, such as a Young's modulus greater than or equal to about 35 Mpsi, greater than or equal to about 40 Mpsi, or greater than or equal to about 45 Mpsi. Such a configuration may allow for, e.g., bearings 1152, 1160 having an increased stiffness and, thus, may allow for more accurate and precise operation of the respective bearings.

The above-described embodiments facilitate providing a gas turbine engine with a smaller variable pitch fan that can generate larger amounts of thrust. Particularly, the above-described embodiments facilitate providing a gas turbine engine with a variable pitch fan having, e.g., a larger pitch range, a higher blade count, a lower/shorter blade length, a lower hub to fan radius ratio, a lower fan pressure ratio, and/or an increased solidity in a root region of the blades. Such variable pitch can increase the fan's efficiency, which can decrease the fuel burn during operation and can otherwise improve the engine's performance, for example.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

The gas turbine engine of any preceding clause, wherein the thrust to power airflow ratio and the core bypass ratio are defined when the gas turbine engine is operated at a rated speed during standard day operating conditions.

The gas turbine engine of any preceding clause, wherein the thrust to power airflow ratio between 4 and 75.

The gas turbine engine of any preceding clause, wherein the primary fan is an unducted primary fan, and wherein the thrust to power airflow ratio between 30 and 60.

The gas turbine engine of any preceding clause, wherein the thrust to power airflow ratio between 35 and 50.

The gas turbine engine of any preceding clause, wherein the core bypass ratio between 0.3 and 5.

The gas turbine engine of any preceding clause, wherein the gas turbine engine is a turboprop engine, and wherein the thrust to power airflow ratio between 40 and 100.

The gas turbine engine of any preceding clause, wherein the primary fan is a ducted primary fan, and wherein the thrust to power airflow ratio is between 3.5 and 40.

The gas turbine engine of any preceding clause, wherein the gas turbine engine is a direct drive gas turbine engine, and wherein the thrust to power airflow ratio is between 3.5 and 20.

The gas turbine engine of any preceding clause, wherein the gas turbine engine is a geared gas turbine engine, and wherein the thrust to power airflow ratio is between 8 and 40.

The gas turbine engine of any preceding clause, wherein the secondary fan is a single stage secondary fan.

The gas turbine engine of any preceding clause, wherein the secondary fan is a multi-stage secondary fan.

The gas turbine engine of any preceding clause, wherein the multi-stage secondary fan is a two stage secondary fan.

The gas turbine engine of any preceding clause, wherein the primary fan is a ducted primary fan comprising an outer nacelle surrounding the primary fan and defining the bypass passage downstream of the primary fan and over the turbomachine, wherein the gas turbine engine further defines a bypass passage outlet at a downstream end of the outer nacelle, wherein the fan duct defines a fan duct outlet, and wherein the fan duct outlet is downstream of the bypass passage outlet.

The gas turbine engine of any preceding clause, wherein the primary fan is a ducted primary fan comprising an outer nacelle surrounding the primary fan and defining the bypass passage downstream of the primary fan and over the turbomachine, wherein the gas turbine engine further defines a bypass passage outlet at a downstream end of the outer nacelle, wherein the fan duct defines a fan duct outlet, and wherein the fan duct outlet is upstream of the bypass passage outlet.

The gas turbine engine of any preceding clause, wherein the primary fan, the secondary fan, the compressor section, the combustion section, and the turbine section are arranged in serial flow order.

A method of operating a gas turbine engine, comprising: operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5, wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct.

The gas turbine engine of any preceding clause, wherein the thrust to power airflow ratio between 4 and 75.

The method of any preceding clause, wherein the primary fan is an unducted primary fan, and wherein the thrust to power airflow ratio between 30 and 60.

The method of any preceding clause, wherein the thrust to power airflow ratio between 35 and 50.

The method of any preceding clause, wherein the core bypass ratio between 0.3 and 5.

A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct, and wherein the primary fan is a variable pitch fan, the variable pitch fan including: a plurality of fan blades coupled to a disk, each fan blade of the plurality of fan blades extending radially outward from the disk, each fan blade extending along a span from a root to a tip, a portion of the span adjacent the root defining a root span region, a portion of the span adjacent the tip defining a tip span region, wherein each fan blade is rotatable about a pitch axis to vary a pitch of the fan blade, the pitch axis extending radially through the fan blade, the pitch variable within a pitch range.

The gas turbine engine of any of the preceding clauses, wherein the pitch range is at least 80°.

The gas turbine engine of any of the preceding clauses, wherein the pitch range extends from 80° to 130°.

The gas turbine engine of any of the preceding clauses, wherein the pitch range is about 130°.

The gas turbine engine of any of the preceding clauses, wherein the pitch range corresponds to the variation in pitch between a feather pitch position and a reverse pitch position.

The gas turbine engine of any of the preceding clauses, wherein the pitch range corresponds to the variation in pitch between a flat pitch position and a reverse pitch position.

The gas turbine engine of any of the preceding clauses, wherein a solidity of the variable pitch fan is at least 1.0 in the root span region.

The gas turbine engine of any of the preceding clauses, wherein the solidity of the variable pitch fan is less than 1.0 in the tip span region.

The gas turbine engine of any of the preceding clauses, further including a rotatable front hub covering the disk.

The gas turbine engine of any of the preceding clauses, wherein a fan hub radius ratio of the variable pitch fan is less than about 0.40.

The gas turbine engine of any of the preceding clauses, wherein the plurality of fan blades comprises at least ten fan blades.

The gas turbine engine of any of the preceding clauses, wherein a fan pressure ratio of the variable pitch fan is less than about 1.5.

The gas turbine engine of any of the preceding clauses, further including: a pitch change actuation assembly for varying the pitch of the plurality of fan blades, the actuation assembly including: a scheduling ring rotatable relative to the disk and defining a plurality of slots, a plurality of linkage arms, and a plurality of sliding members, wherein each linkage arm is coupled to one fan blade of the plurality of fan blades, each sliding member is rotatably connected to one linkage arm of the plurality of linkage arms, and each sliding member is slidably coupled to one slot of the plurality of slots to operatively couple the fan blades to the slots.

The gas turbine engine of any of the preceding clauses, wherein the plurality of slots includes at least one linear slot and at least one non-linear slot.

The gas turbine engine of any of the preceding clauses, wherein each of the plurality of fan blades rotates according to a blade pitch schedule defined by the slot to which it is operatively coupled.

The gas turbine engine of any of the preceding clauses, wherein at least two of the plurality of slots define different blade pitch schedules.

The gas turbine engine of any of the preceding clauses, wherein the pitch change actuation assembly provides asynchronous variation of fan blade pitch.

The gas turbine engine of any of the preceding clauses, further including a plurality of trunnion mechanisms to couple each of the plurality of fan blades to the disk, each trunnion mechanism including a bearing having one or more components comprised of a non-ferrous material.

The gas turbine engine of any of the preceding clauses, wherein the bearing is a tapered roller bearing.

The gas turbine engine of any of the preceding clauses, wherein the variable pitch fan is unducted.

We claim:

1. A gas turbine engine comprising:
a turbomachine comprising a compressor section, a combustion section, and a turbine section arranged in serial flow order, the turbomachine defining an engine inlet to an inlet duct, a fan duct inlet to a fan duct, and a core inlet to a core duct;
a primary fan driven by the turbomachine; and
a secondary fan located downstream of the primary fan within the inlet duct,
the gas turbine engine defining a thrust to power airflow ratio between 3.5 and 100 and a core bypass ratio between 0.1 and 10,
wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct, and
wherein the primary fan is a variable pitch fan, the variable pitch fan including:
a plurality of fan blades coupled to a disk, each fan blade of the plurality of fan blades extending radially outward from the disk, each fan blade extending along a span from a root to a tip, a portion of the span adjacent the root defining a root span region, a portion of the span adjacent the tip defining a tip span region,
wherein each fan blade is rotatable about a pitch axis to vary a pitch of the fan blade, the pitch axis extending radially through the fan blade, the pitch variable within a pitch range.

2. The gas turbine engine of claim 1, wherein the pitch range is at least 80°.

3. The gas turbine engine of claim 1, wherein the pitch range extends from 80° to 130°.

4. The gas turbine engine of claim 1, wherein the pitch range is about 130°.

5. The gas turbine engine of claim 1, wherein the pitch range corresponds to the variation in pitch between a feather pitch position and a reverse pitch position.

6. The gas turbine engine of claim 1, wherein the pitch range corresponds to the variation in pitch between a flat pitch position and a reverse pitch position.

7. The gas turbine engine of claim 1, wherein a solidity of the variable pitch fan is at least 1.0 in the root span region.

8. The gas turbine engine of claim 7, wherein the solidity of the variable pitch fan is less than 1.0 in the tip span region.

9. The gas turbine engine of claim 1, further including a rotatable front hub covering the disk.

10. The gas turbine engine of claim 9, wherein a fan hub radius ratio of the variable pitch fan is less than about 0.40.

11. The gas turbine engine of claim 1, wherein the plurality of fan blades comprises at least ten fan blades.

12. The gas turbine engine of claim 1, wherein a fan pressure ratio of the variable pitch fan is less than about 1.5.

13. The gas turbine engine of claim 1, further including:
a pitch change actuation assembly for varying the pitch of the plurality of fan blades, the pitch change actuation assembly including:
a scheduling ring rotatable relative to the disk and defining a plurality of slots,
a plurality of linkage arms, and
a plurality of sliding members,
wherein each linkage arm is coupled to one fan blade of the plurality of fan blades, each sliding member is rotatably connected to one linkage arm of the plurality of linkage arms, and each sliding member is slidably coupled to one slot of the plurality of slots to operatively couple the fan blades to the slots.

14. The gas turbine engine of claim 13, wherein the plurality of slots includes at least one linear slot and at least one non-linear slot.

15. The gas turbine engine of claim 13, wherein each of the plurality of fan blades rotates according to a blade pitch schedule defined by the slot to which it is operatively coupled.

16. The gas turbine engine of claim 15, wherein at least two of the plurality of slots define different blade pitch schedules.

17. The gas turbine engine of claim 15, wherein the pitch change actuation assembly provides asynchronous variation of fan blade pitch.

18. The gas turbine engine of claim 1, further including a plurality of trunnion mechanisms to couple each of the plurality of fan blades to the disk, each trunnion mechanism including a bearing having one or more components comprised of a non-ferrous material.

19. The gas turbine engine of claim 18, wherein the bearing is a tapered roller bearing.

20. The gas turbine engine of claim 1, wherein the variable pitch fan is unducted.
